(19) United States
(12) Patent Application Publication
(10) Pub. No.: US 2018/0329260 A1
(43) Pub. Date: Nov. 15, 2018

(54) LIQUID CRYSTAL DISPLAY DEVICE

(71) Applicant: Sharp Kabushiki Kaisha, Sakai City, Osaka (JP)

(72) Inventors: MASANOBU MIZUSAKI, Sakai City (JP); YUKO TERAOKA, Sakai City (JP)

(21) Appl. No.: 15/527,703

(22) PCT Filed: Nov. 13, 2015
(86) PCT No.: PCT/JP2015/081986

§ 371 Date: May 17, 2017

(30) Foreign Application Priority Data
Nov. 18, 2014 (JP) JP2014-233969

(51) Int. Cl. G02F 1/1337; G02F 1/1339; G02F 1/137; C09K 19/56; C09K 19/54

(52) U.S. Cl. CPC G02F 1/133719; G02F 1/133788; G02F 1/1339; G02F 2001/133397; C09K 19/56; C09K 19/54; G02F 2001/13712; G02F 1/137

(57) ABSTRACT

The present invention provides a liquid crystal display device which maintains a good voltage holding ratio for a long term and prevents an occurrence of image sticking and generation of stain on a display screen, by using a photo-alignment film. The liquid crystal display device according to the present invention includes a liquid crystal layer containing liquid crystal molecules and an antioxidant, a sealing material obtained by curing a sealing resin which contains a compound having at least one first bonding functional group which is selected from the group consisting of an epoxy group, a methoxy silane group, and an ethoxy silane group, and a photo-alignment film containing at least one alignment film polymer which includes an ester group. The at least one alignment film polymer includes a photo-alignment film polymer which includes at least one photo-functional group selected from the group consisting of a cinnamate group, a chalconyl group, an azobenzene group, a coumarin group, a stilbene group, and a phenol ester group. At least one second bonding functional group which is selected from the group consisting of —COOH, —NH₂, —NHR, —SH, and —OH is provided on the surface of the photo-alignment film.

### TECHNICAL FIELD

The present invention relates to a liquid crystal display device. More specifically, the present invention relates to a liquid crystal display device in which alignment of liquid crystal molecules is controlled by an alignment film.

### BACKGROUND ART

A liquid crystal display device is a display device using a liquid crystal composition for display. As a representative display method for the liquid crystal display device, a method as follows is provided. A liquid crystal panel in which a liquid crystal composition is sealed between a pair of substrates is irradiated with light from a backlight. A voltage is applied to the liquid crystal composition so as to change alignment of liquid crystal molecules. Thus, the quantity of light transmitted through the liquid crystal panel is controlled. Such a liquid crystal display device has features of being thin, lightweight, and low power consumption. Accordingly, the liquid crystal display device is used in electronic devices such as a smartphone, a tablet PC, and a car navigation.

In a liquid crystal display device, alignment of liquid crystal molecules in a state where a voltage is not applied is generally controlled by an alignment film subjected to alignment treatment. As a method of the alignment treatment, a rubbing method in which the surface of an alignment film is rubbed with a roller or the like is widely used in the related art. In recent years, resolution of pixels has been increased for the use of a smartphone and the like. With a higher resolution, the number or the area of wires or black matrices provided in a liquid crystal panel is increased, and a step is easily generated on the surface of a substrate in the liquid crystal panel. If a step is generated on the surface of a substrate, it may not be possible to appropriately rub the vicinity of the step by the rubbing method. If alignment treatment is not uniformly performed, a contrast ratio in a liquid crystal display device may be degraded.

Regarding this, research and development for a photo-alignment method, as a method for alignment treatment instead of the rubbing method, of irradiating the surface of an alignment film with light is in progress. According to such photo-alignment method, since alignment treatment can be performed without in contact with the surface of an alignment film, there are advantages in that an unevenness in alignment treatment is unlikely to occur even if a step has been made on the surface of a substrate, and good liquid crystal alignment can be realized over the entire surface of the substrate. Further, it is possible to achieve high contrast, high luminance, reduced power consumption, high-speed response, and high resolution by using the photo-alignment method.

In the related art, polyamic acid and polyimide are often used as a material (liquid crystal aligning agent) of an alignment film. Polyamic acid and polyimide exhibit excellent physical properties in heat resistance, affinity with liquid crystal, mechanical strength, and the like, among organic resins. However, as the range of using the liquid crystal panel is expanded and use environments are diversified, a material having more excellent heat resistance is required. Thus, an alignment film using a polymer which has polysiloxane as the main skeleton is proposed (for example, see PTLs 1 to 4).

PTL 1 discloses a liquid crystal aligning agent including polyorganosiloxane having a cinnamate skeleton, and polyamic acid or polyimide.

PTL 2 discloses that a vertically-aligned siloxane polymer is used for an alignment film, and thus stability in alignment of liquid crystal is improved. The technology disclosed in PTL 2 intends to cause alignment to be more stable by using the PSA technology. In the technology, a siloxane polymer is used for effectively removing a residual monomer in a liquid crystal layer when a polymer layer is formed. A vertical photo-alignment film in which a cinnamate group as a photo-functional group is introduced into a side chain of a siloxane polymer and a sealing material of an UV/thermal curing type are disclosed.

PTL 3 discloses that an alignment film material including a liquid crystal alignment side chain which has a C—C double bond which is bonded to silicon is used in a vertical alignment film having a siloxane structure and a thermally-crosslinking group (epoxy group).

PTL 4 discloses a liquid crystal aligning agent which contains a matter generated by a reaction between a specific compound and at least one selected from the group consisting of polysiloxane having a specific structure of a side chain repeatedly in a unit, a hydrolysate thereof, and a condensate of the hydrolysate. PTL 4 also discloses that the liquid crystal aligning agent may further contain at least one selected from a group consisting of polyamic acid and polyimide, and the liquid crystal aligning agent is used for a liquid crystal display element.

Regarding a liquid crystal composition used in a liquid crystal display device, improvement of stability is desired so that the liquid crystal composition can endure a load in a process of manufacturing the liquid crystal display device, and the manufactured liquid crystal display device can exhibit characteristics stably for a long term. For example, PTL 5 discloses that an antioxidant and a photostabilizer are added to a liquid crystal composition. PTL 6 also discloses that a stabilizer is added to a liquid crystal composition (see Table C of the paragraphs [0208] to [0211]).

### CITATION LIST

### Patent literature

PTL 1: Japanese Unexamined Patent Application Publication No. 2009-258650

PTL 2: Japanese Unexamined Patent Application Publication No. 2012-234178

PTL 3: Japanese Unexamined Patent Application Publication No. 2012-141567

PTL 4: International Publication No. 2009/025385

PTL 5: Japanese Unexamined Patent Application Publication No. 2007-197731

PTL 6: Japanese Unexamined Patent Application Publication (Translation of PCT Application) No. 2011-515543

### SUMMARY OF INVENTION

### Technical Problem

As described above, the photo-alignment method has been used to respond to a higher resolution of pixels. However, as a result, when a liquid crystal display device is used for a long term, stain may occur around a sealing material or image sticking may occur in a display area. This phenomenon is significantly observed, particularly, in a photo-alignment film having a cinnamate group.

As a result obtained by examinations of the inventors, it was recognized that, in a liquid crystal display device using a photo-alignment film, adhesive strength between the photo-alignment film and a sealing material was not sufficient, and thus moisture was infiltrated from a space between the photo-alignment film and the sealing material. The infiltrated moisture causes an ester group included in a side chain or a photo-functional group of a polymer (alignment film polymer) constituting a photo-alignment film to be cleaved and the separated side chain portion is eluted into a liquid crystal layer. Thus, stain occurs around the sealing material. According to the examinations of the inventors, the reason why adhesive strength is insufficient between the photo-alignment film and the sealing material is that interaction is insufficient between photo-alignment side chain having low polarity and the sealing material having high polarity.

In addition, the photo-functional group of the photo-alignment film is cleaved by light of a backlight, and thus forms radicals. If the radicals are eluted into the liquid crystal layer, the existence of the moisture causes the radicals to be changed to be soluble ions in the liquid crystal layer. Thus, image sticking in the display area occurs. If an antioxidant is introduced into the liquid crystal layer in order to prevent oxidation of a liquid crystal material, it is possible to cause the radicals which are eluted in the liquid crystal layer to react with the antioxidant. However, the antioxidant is consumed by the reaction. Thus, in a case where the liquid crystal display device is used for a long term, the function of preventing oxidation is gradually decreased. Accordingly, oxides generated from the liquid crystal material, the alignment film material, and the sealing material may be ionized, and this may be the cause of image sticking.

Considering the above situation, an object of the present invention is to provide a liquid crystal display device that uses a photo-alignment film, maintains a good voltage holding ratio for a long term, and prevents an occurrence of image sticking and stain on a display screen.

### Solution to Problem

The inventors examined a method of preventing the occurrence of image sticking and stain in a liquid crystal display device including a photo-alignment film. As a result, the inventors found that a hydrogen-bonding functional group (also referred to as “second bonding functional group” in this specification) such as —COOH (carboxyl group) was introduced to the surface of the photo-alignment film, and thus it was possible to prevent the occurrence of image sticking and stain.

As a first method for causing a hydrogen-bonding functional group to be provided on the surface of the photo-alignment film, a method was found in which the hydrogen-bonding functional group was introduced into a polymer having a photo-functional group, and was introduced into a terminal of a side chain instead of being introduced into a main chain or the vicinity of the main chain. Further, as a second method, a method was found in which a photo-alignment film where a polymer having a photo-functional group and a polymer having a hydrogen-bonding functional group were mixed with each other was used, and a mixing ratio of the polymer having the hydrogen-bonding functional group was set to be relatively large.

It was confirmed that the hydrogen-bonding functional group is provided on the surface of the photo-alignment film, and thus the following effects were obtained.

[Suppression of Moisture Infiltration from Space Between Photo-Alignment Film and Sealing Material]

Hydro bonding-related interaction occurs between the hydrogen-bonding functional group and a silane coupling agent or an epoxy group (epoxy compound or epoxy group in the silane coupling agent) in the sealing material, or a covalent bond of the hydrogen-bonding functional group to the silane coupling agent or the epoxy group is formed. Thus, adhesive strength between the photo-alignment film and the sealing material is improved, and it is possible to suppress moisture infiltration.

[Suppression of Consumption of Antioxidant in Liquid Crystal]

The photo-functional group such as a cinnamate group, a chalconyl group, an azobenzene group, and a coumarin group is cleaved by irradiation with backlight light, and thus forms radicals. If the radicals are eluted into the liquid crystal layer and react with the antioxidant in the liquid crystal layer, and thus the antioxidant is consumed, ions are generated by oxidation of the liquid crystal material, the alignment film material, and the sealing material. By the contrary, if the hydrogen-bonding functional group is introduced into the surface of the photo-alignment film, radicals formed by cleaving the photo-functional group can be deactivated by the hydrogen-bonding functional group. Thus, it is possible to suppress consumption of the antioxidant.

[Others: Crosslinking Between Alignment Film Polymers]

In a case where an epoxy group is provided in the side chain of the alignment film polymer, crosslinks are formed between alignment film polymer molecules. Crosslinking of the alignment film polymer allows elution of radicals or the like from the photo-alignment film into the liquid crystal layer to be suppressed. Thus, it is possible to suppress a decrease of a voltage holding ratio (VHR).

With the above descriptions, the inventors consider that the above problems may be completely solved, and achieve the present invention.

That is, a liquid crystal display device according to an aspect of the present invention may include a pair of substrates, a liquid crystal layer which is interposed between the pair of substrates, a sealing material which is disposed around the liquid crystal layer and bonds the pair of substrates to each other, and a photo-alignment film which is disposed between at least one of the pair of substrates, and the liquid crystal layer and the sealing material. The liquid crystal layer may contain liquid crystal molecules and an antioxidant. The sealing material may be obtained by curing a sealing resin which contains a compound having at least one first bonding functional group which is selected from the group consisting of an epoxy group, a methoxy silane group, and an ethoxy silane group. The photo-alignment film may contain at least one alignment film polymer which includes an ester group in a main chain or a side chain. The at least one alignment film polymer may include a photo-alignment film polymer which includes at least one photo-functional group selected from the group consisting of a cinnamate group, a chalconyl group, an azobenzene group, a coumarin group, a stilbene group, and a phenol ester group. At least one second bonding functional group which is selected from the group consisting of —COOH, —NH₂, —NHR (R indicates an aliphatic or alicyclic hydrocarbon having 1 to 18 carbon atoms, or indicates a structure in which a hydroxyl group and/or a halogen group is added to the hydrocarbon), —SH, and —OH may be provided on a surface of the photo-alignment film.

### Advantageous Effects of Invention

According to the liquid crystal display device of the present invention, with the above-described configuration, it is possible to improve adhesive strength of the photo-alignment film to the sealing material or to deactivate radicals generated from the photo-functional group or the ester group, by the second bonding functional group provided in the surface of the photo-alignment film. Thus, it is possible to maintain a good voltage holding ratio for a long term and prevent the occurrence of image sticking and stain on a display screen, by using the photo-alignment film.

### BRIEF DESCRIPTION OF DRAWINGS

FIG. 1 is a schematic sectional view illustrating a liquid crystal panel and a backlight according to an embodiment.

FIG. 2 is a schematic plan view illustrating the liquid crystal panel according to the embodiment.

FIG. 3 is a diagram illustrating an action of a phenol antioxidant in the present invention.

FIG. 4 is a schematic diagram illustrating a surface state of an alignment film in the related art, which uses an alignment film polymer in which the main chain is formed of polyamic acid and a second bonding functional group is not given to the terminal of a side chain.

FIG. 5 is a schematic diagram illustrating a surface state of a photo-alignment film in the embodiment, which uses an alignment film polymer in which the second bonding functional group is given to the terminal of the side chain.

FIG. 6(a) is a schematic diagram illustrating an adhesion state between the photo-alignment film and a sealing material in the embodiment, and FIG. 6(b) illustrates an example of a chemical bond formed at an interface between the photo-alignment film and the sealing material in the embodiment.

FIG. 7 is a diagram illustrating an action of an antioxidant on the alignment film in the related art, which uses the alignment film polymer in which the second bonding functional group is not given to the terminal of the side chain.

FIG. 8 is a diagram illustrating an action of the second bonding functional group in the alignment film in the embodiment.

FIG. 9 is a diagram illustrating an action of the second bonding functional group in the photo-alignment film in the embodiment when the side chain including an epoxy group is provided.

FIG. 10 is a schematic perspective view illustrating a relationship between a photo-alignment treatment direction and a pretilt direction of a liquid crystal molecule in a VATN mode liquid crystal display device.

FIG. 11(a) is a schematic plan view illustrating a direction of an average liquid crystal director in one pixel (1 pixel or 1 subpixel) and a photo-alignment treatment direction with respect to a pair of substrates (upper and lower substrates), in a case where the VATN mode liquid crystal display device has a monodomain and FIG. 11(b) is a schematic diagram illustrating a direction of an absorption axis of a polarizer provided in the liquid crystal display device illustrated in FIG. 11(a).

FIG. 12 is a schematic sectional view illustrating a first arrangement relationship between the substrate and a photomask in a photo-alignment treatment process for performing alignment division by a proximity exposure method using an alignment mask.

FIG. 13 is a schematic sectional view illustrating a second arrangement relationship between the substrate and the photomask in the photo-alignment treatment process for performing alignment division by the proximity exposure method using the alignment mask.

FIG. 14(a) is a schematic plan view illustrating a direction of an average liquid crystal director in one pixel (1 pixel or 1 subpixel), the photo-alignment treatment direction with respect to the pair of substrates (upper and lower substrates), and a division pattern for 4 domains, in a case where the liquid crystal display device has the 4 domains and FIG. 14(b) is a schematic diagram illustrating a direction of an absorption axis of a polarizer provided in the liquid crystal display device illustrated in FIG. 14(a).

FIG. 15(a) is a schematic plan view illustrating a direction of an average liquid crystal director in one pixel (1 pixel or 1 subpixel), the photo-alignment treatment direction with respect to the pair of substrates (upper and lower substrates), and a division pattern for the other 4 domains, in a case where the liquid crystal display device has the other 4 domains, FIG. 15(b) is a schematic diagram illustrating a direction of an absorption axis of the polarizer provided in the liquid crystal display device illustrated in FIG. 15(a), and FIG. 15(c) is a schematic sectional view illustrating a section taken along line A-B line in FIG. 15(a) when an AC voltage of a threshold or higher is applied between the pair of substrates. FIG. 15(c) illustrates alignment directions of liquid crystal molecules.

FIG. 16 is a schematic diagram illustrating a configuration of a FFS mode liquid crystal panel, which is manufactured in Examples 23 to 27 and Comparative Example 5.

### DESCRIPTION OF EMBODIMENTS

Hereinafter, an embodiment of the present invention will be described. The present invention is not limited to details described in the following embodiment, and the design thereof can be appropriately changed in a range of satisfying the configuration of the present invention.

According to the embodiment, there is provided a liquid crystal display device which includes a pair of substrates, a liquid crystal layer which is interposed between the pair of substrates, a sealing material which is disposed around the liquid crystal layer and bonds the pair of substrates to each other, and a photo-alignment film which is disposed between at least one of the pair of substrates, and the liquid crystal layer and the sealing material. The liquid crystal layer contains liquid crystal molecules and an antioxidant. The sealing material is obtained by curing a sealing resin which contains a compound having at least one first bonding functional group which is selected from the group consisting of an epoxy group, a methoxy silane group, and an ethoxy silane group. The photo-alignment film contains at least one alignment film polymer which includes an ester group in a main chain or a side chain. The at least one alignment film polymer includes a photo-alignment film polymer which includes at least one photo-functional group selected from the group consisting of a cinnamate group, a chalconyl group, an azobenzene group, a coumarin group, a stilbene group, and a phenol ester group. At least one second bonding functional group which is selected from the group consisting of —COOH, —NH₂, —NHR (R indicates an aliphatic hydrocarbon having 1 to 18 carbon atoms, or indicates a structure in which a hydroxyl group and/or a halogen group is added to the hydrocarbon), —SH, and —OH is provided on the surface of the photo-alignment film.

[Overall Configuration of Liquid Crystal Display Device]

The liquid crystal display device according to the embodiment includes a plurality of members, for example, a liquid crystal panel; an external circuit such as a tape carrier package (TCP) and a printed circuit board (PCB); an optical film such as a viewing angle widening film and a luminance improving film; a backlight unit; and a bezel (frame). Some members may be mounted in other members in accordance with the type of the members. The members other than the liquid crystal panel are not particularly limited, and components which are generally used in the field of the liquid crystal display device can be used. Thus, descriptions thereof will be not omitted.

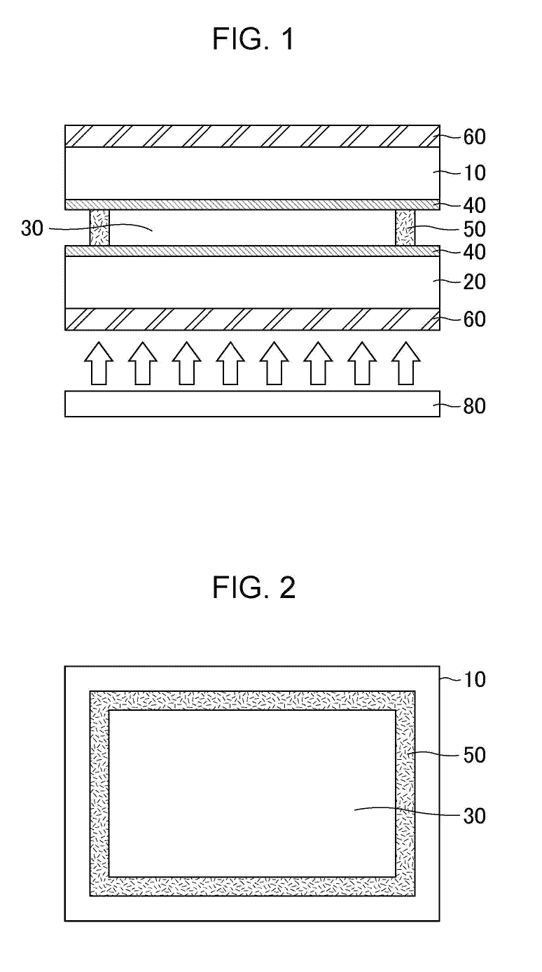

FIG. 1 is a schematic sectional view illustrating a liquid crystal panel and a backlight according to an embodiment. FIG. 2 is a schematic plan view illustrating the liquid crystal panel according to the embodiment. As illustrated in FIG. 1, the liquid crystal display device according to the embodiment includes a pair of substrates 10 and 20. A liquid crystal layer 30 is interposed between the pair of substrates 10 and 20. An electrode for applying a voltage to the liquid crystal layer 30 is provided on one or both of the pair of substrates 10 and 20.

A photo-alignment film 40 is interposed between at least one of the pair of substrates 10 and 20 and the liquid crystal layer 30. In FIG. 1, the photo-alignment film 40 is provided at both of a space between one substrate 10 and the liquid crystal layer 30 and a space between the other substrate 20 and the liquid crystal layer 30. However, the photo-alignment film 40 may be provided only at one of the spaces. When a voltage is not applied to the liquid crystal layer 30 through electrodes, mainly, alignment of the liquid crystal layer 30 is controlled by an operation of the photo-alignment film 40. If a voltage is applied to the liquid crystal layer 30 through the electrodes, alignment of liquid crystal molecules in the liquid crystal layer 30 is changed in accordance with the magnitude of the applied voltage.

The pair of substrates 10 and 20 are adhered to each other by a sealing material 50. As illustrated in FIG. 2, the sealing material 50 is disposed to surround the liquid crystal layer 30. Polarizers 60 are disposed on an outer side of a liquid crystal panel which is an opposite side of a side on which the photo-alignment film 40 is disposed based on the substrates 10 and 20, respectively. As the polarizer 60, typically, a component obtained by adhering and aligning an anisotropic material such as an iodine complex having dichroism to a polyvinyl alcohol (PVA) film is exemplified. Generally, a component obtained by laminating a protective film such as a triacetyl cellulose film on both surfaces of a PVA film is practically used. An optical film such as a phase difference film may be disposed between the polarizer 60 and the substrates 10 and 20.

[Pair of Substrates]

Examples of the pair of substrates 10 and 20 include a combination of an active matrix substrate and a color filter substrate. In an active matrix type display method, generally, when an active element such as a thin-film transistor (TFT), which is provided in each pixel is in an ON state, a signal voltage is applied to an electrode through the TFT. Charges charged at this time are held in a period when the active element is in the ON state. A voltage holding ratio (VHR) indicates a ratio of the remaining charges after the charged charges are held in one frame period (for example, 16.7 ms). That is, a low VHR means that the voltage applied to the liquid crystal layer 30 is easily attenuated with time. In the active matrix type display method, a high VHR is required.

As the active matrix substrate, a substrate which is generally used in the field of the liquid crystal display device can be used. As a configuration when the active matrix substrate is viewed in a plan view, a configuration as follows is exemplified. A plurality of gate signal lines which are parallel to each other; a plurality of source signal lines which are extended in a direction perpendicular to the gate signal line and are formed to be parallel to each other; an active element such as a TFT, which is disposed to correspond to an intersection between the gate signal line and the source signal line; a pixel electrode which is disposed in a matrix in a region partitioned by the gate signal line and the source signal line; and the like are provided on a transparent substrate. In a case of a horizontal alignment mode, a common wire; a common electrode connected to the common wire; and the like are further provided. As the TFT, a TFT in which a channel is formed by amorphous silicon, polysilicon, or In—Ga—Zn—O(indium-gallium-zinc-oxygen) which is an oxide semiconductor is suitably used. In particular, the oxide semiconductor has off-leak characteristics. Thus, the oxide semiconductor is advantageous for low-frequency driving of a liquid crystal display device. However, in a case where the VHR of the liquid crystal layer 30 is low, low-frequency driving is not performed. With the present invention, it is possible to increase the VHR of the liquid crystal layer 30, and thus to perform low-frequency driving. That is, a combination of an oxide semiconductor and the present invention is particularly suitable.

As the color filter substrate, a substrate which is generally used in the field of the liquid crystal display device can be used. As a configuration of the color filter substrate, a configuration in which a black matrix formed to have a grid shape, a color filter formed on an inner side of a lattice, that is, a pixel, and the like are provided on a transparent substrate is exemplified. In a case of a vertical alignment mode, a common electrode and the like which is formed to cover the black matrix and the color filter is further provided.

Regarding the pair of substrates 10 and 20, both of the color filter and the active matrix may be formed on one side substrate.

[Liquid Crystal Layer]

In the embodiment, the liquid crystal layer 30 contains liquid crystal molecules and an antioxidant.

<Liquid Crystal Molecule>

Liquid crystal molecules may be liquid crystal molecules in which dielectric anisotropy (Δε) defined by the following Expression (P) has a negative value or may be liquid crystal molecules in which the dielectric anisotropy (Δε) has a positive value. That is, the liquid crystal molecules may have negative dielectric anisotropy or may have positive dielectric anisotropy. As the liquid crystal molecules having negative dielectric anisotropy, for example, liquid crystal molecules having Δε of −1 to −20 can be used. As the liquid crystal material having positive dielectric anisotropy, for example, liquid crystal molecules having Δε of 1 to 20 can be used.

Δε=(dielectric constant in a major-axis direction)−(dielectric constant in a minor-axis direction) (P)

In a liquid crystal display device in the related art, in a case using a liquid crystal material having negative dielectric anisotropy, the problem for image sticking and stain tends to appear more clearly in comparison to a case using a liquid crystal material having positive dielectric anisotropy. The reason is supposed as follows. In a liquid crystal material having negative dielectric anisotropy, large polarization is provided in a minor-axis direction. Thus, a large influence of a decrease of the VHR at a time of ionization is applied. That is, the antioxidant used in the present invention exhibits a large effect in a system using a liquid crystal material which has negative dielectric anisotropy.

<Antioxidant>

The antioxidant is not particularly limited as long as the antioxidant has reactivity with oxygen or oxide, which is higher than reactivity with the liquid crystal molecule. For example, a phenol antioxidant is suitably used. In the embodiment, the second bonding functional group is introduced into the photo-alignment film 40, and thus adhesive strength between the photo-alignment film 40 and the sealing material 50 is improved. However, it is possible to prevent oxidation of the liquid crystal material, the photo-alignment film 40, and the sealing material 50 and to further improve long-term reliability, by adding the antioxidant.

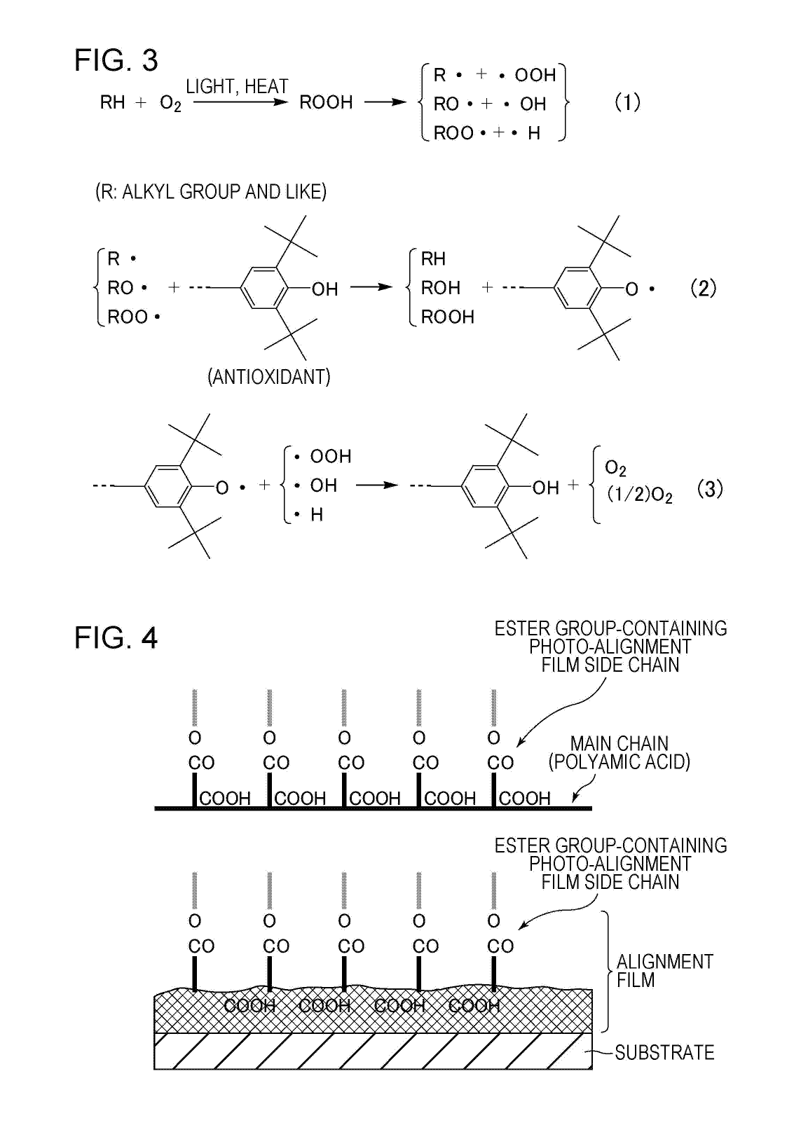

FIG. 3 is a diagram illustrating an action of a phenol antioxidant in the present invention. As shown in Formula (1) in FIG. 3, if oxygen is infiltrated into a liquid crystal panel and then energy of light or heat is applied to the liquid crystal panel, an alkyl group (R) and the like which are included in the liquid crystal material, the photo-alignment film 40, or the sealing material 50 is oxidized, and an oxidized substance (ROOH) is generated. Radicals are generated from oxidized substances. The generated radicals are ionized under a condition in which the antioxidant is not provided. In a case where the liquid crystal material is oxidized and ionized, ions are generated in the liquid crystal layer 30. In addition, in a case where the photo-alignment film 40 or the sealing material 50 is oxidized, oxidized substances which are separated from a polymer constituting the photo-alignment film 40 or the sealing material 50 are also ionized and eluted into the liquid crystal layer 30. Thus, ions are generated in the liquid crystal layer 30. Accordingly, ions in the liquid crystal layer 30 cause the VHR to be decreased. The antioxidant is added, and thus, as shown in Formulas (2) and (3) in FIG. 3, reaction with the antioxidant can be caused before radicals are ionized. Thus, it is possible to prevent generation of ions which occur by oxidation of the liquid crystal material, the photo-alignment film 40, and the sealing material 50. According to a cycle shown in Formulas (2) and (3) in FIG. 3, the amount of the antioxidant is not reduced. Thus, it is possible to prevent ionization of radicals for a long term.

As illustrated in FIG. 3, the antioxidant repeats a cycle of separation of a hydrogen group→addition→separation, and thus the antioxidant has a function of separating (reducing) oxygen from oxide and suppresses deterioration (decomposition or ionization) occurring by oxidation, for a long term.

As the phenol antioxidant, for example, a dibutylhydroxyphenyl compound represented by the following Formula (G) is suitable. More specifically, for example, a compound represented by the following Formula (G-1), (G-2), or (G-3) is exemplified.

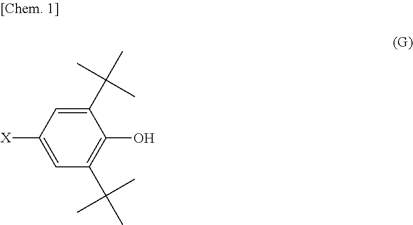

(in Formula (G), X indicates a monovalent organic group.)

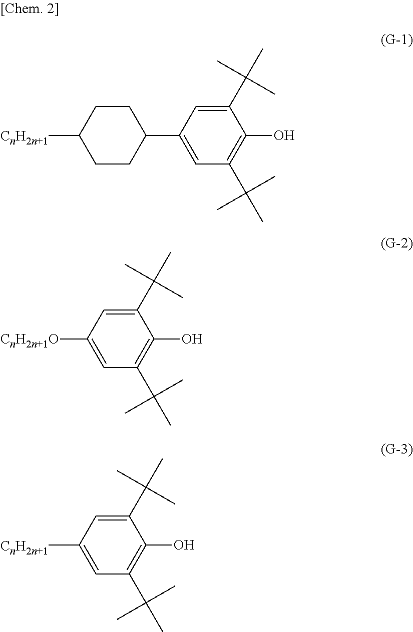

(in Formulas (G-1), (G-2), and (G-3), n indicates an integer which is preferably 3 to 20.)

As a specific example of the dibutylhydroxyphenyl compound represented by the Formula (G), for example, a compound represented by the following Formula (G-a), (G-b), (G-c), (G-d), (G-e), (G-f), or (G-g) is exemplified.

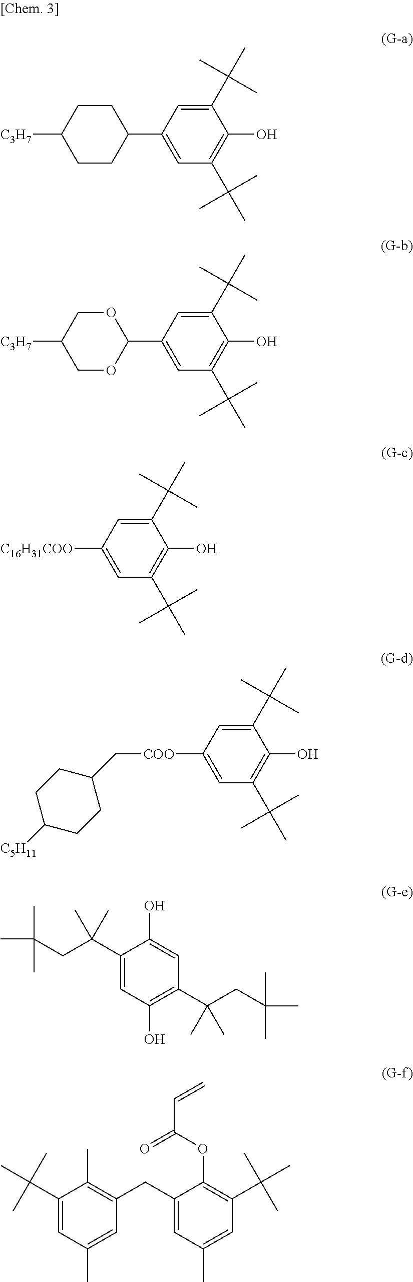

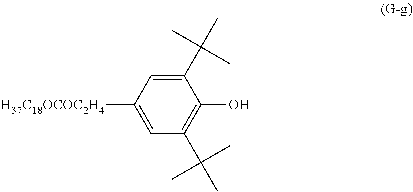

Concentration of the antioxidant is preferably equal to or more than 1 ppm and equal to or less than 10 weight %. If the concentration thereof is in the above range, it is possible to prevent oxygen infiltrated into the liquid crystal panel from the outside thereof from oxidizing the liquid crystal material. Thus, it is possible to effectively prevent the occurrence of image sticking and stain in display due to oxide. The lower limit of the concentration is more preferably 10 ppm. The upper limit thereof is more preferably 5 weight %, and further preferably 1 weight %.

[Sealing Material]

In the embodiment, the sealing material 50 is obtained by curing a sealing resin. The sealing resin contains a compound having at least one first bonding functional group selected from the group consisting of an epoxy group, a methoxy silane group, and an ethoxy silane group. According to the first bonding functional group, the first bonding functional group can form a hydrogen bond or a covalent bond along with the second bonding functional group which is provided on the surface of the photo-alignment film 40. Thus, it is possible to improve adhesive strength between the photo-alignment film 40 and the sealing material 50. A compound containing an epoxy group is not particularly limited. A compound which is generally used as a prepolymer of an epoxy resin, a silane coupling agent having an epoxy group, or the like can be used. A compound having a methoxy silane group and a compound having an ethoxy silane group are not particularly limited. A silane coupling agent which is generally used can be used.

As the silane coupling agent, a substance represented by the following Formula (S) is suitably used. A methoxy silane group (Si—O—CH₃) in the following Formula (S) forms a bond with the second bonding functional group such as —COOH, which is distributed in the surface of the photo-alignment film. Thus, it is possible to improve adhesive strength. The silane coupling agent of the following Formula (S) has an epoxy group in addition to the methoxy silane group.

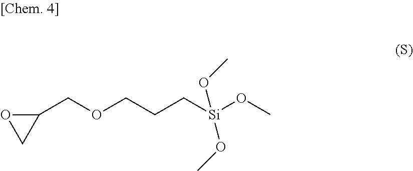

A curing method of a sealing resin is not particularly limited. That is, the sealing resin may be a photocurable resin, a thermosetting resin, or a resin having curability for both of light and heat. Light used for curing the sealing resin may be an ultraviolet ray, visible light, or both of an ultraviolet ray and visible light. In the embodiment, a sealing resin having curability for ultraviolet light or visible light, and heat is suitably used. The sealing resin may contain a polymerization initiator which is suitable for the curing method. For example, the sealing resin may contain a photopolymerization initiator.

The sealing resin may further contain an inorganic filler and/or an organic filler. Examples of the filler include a spacer for controlling a distance between the pair of substrates 10 and 20, and a conductive member for electrically connecting the pair of substrates 10 and 20 to each other.

The liquid crystal panel in the embodiment may be manufactured by a vacuum injection method or be manufactured by a dropping and bonding method. In the vacuum injection method, an opening for injecting liquid crystal is provided at a portion of the sealing material 50 and treatment in which liquid crystal is injected to a space between the pair of substrates 10 and 20, and then the opening portion is sealed is performed. In the dropping and bonding method, the opening for injecting liquid crystal is not provided at a portion of the sealing material 50, and thus the treatment of sealing the opening portion is not performed. Thus, the sealing material 50 formed by the dropping and bonding method is disposed around the liquid crystal layer 30 without being interrupted, and a sealing trace of the opening portion is not provided. In the vacuum injection method, curing treatment of a sealing resin which is the material of the sealing material 50 is completed, and then liquid crystal is injected. However, in the dropping and bonding method, liquid crystal is injected, and then the curing treatment of the sealing resin is performed. Thus, in the curing treatment of a sealing resin in the dropping and bonding method, an exposure condition may be restricted so as not to deteriorate liquid crystal. Thus, ensuring of sufficient adhesive strength at an interface between the photo-alignment film 40 and the sealing material 50 is more difficult than that in a case of the vacuum injection method.

### [Photo-Alignment Film]

The photo-alignment film 40 has a function of controlling alignment of liquid crystal molecules in the liquid crystal layer 30. When a voltage applied to the liquid crystal layer 30 is lower than a threshold voltage (including a case where a voltage is not applied), the alignment of the liquid crystal molecules in the liquid crystal layer 30 is mainly controlled by the motion of the photo-alignment film 40. In this state, an angle formed by the major axis of the liquid crystal molecule to the surfaces of the pair of substrates 10 and 20 is referred to as “a pretilt angle”. In this specification, “the pretilt angle” indicates an angle of an inclination of the liquid crystal molecule from a direction parallel to the surface of the substrate. An angle parallel to the surface of substrate is 0°, and an angle of a line which is normal to the surface of the substrate is 90°.

In the embodiment, the photo-alignment film 40 may be a vertical alignment film which causes liquid crystal molecules to be substantially vertically aligned, or may be a horizontal alignment film which causes the liquid crystal molecules to be substantially horizontally aligned. In a case of the vertical alignment film, the pretilt angle of a liquid crystal molecule, which is given by the photo-alignment film 40 may be in a range which is used in a general vertical alignment mode. The pretilt angle is preferably in a range of 86° or greater and smaller than 90°, and more preferably equal to or smaller than 89.5°. In the vertical alignment mode, it is possible to maintain high contrast by increasing the pretilt angle, and to set a driving voltage not to be too high by setting the pretilt angle to be smaller than 90°. In a VATN mode (also referred to as a 4D-RTN mode) which is one type of the vertical alignment mode, a dark line becomes bolder and an opening ratio is decreased as the pretilt angle approaches 90°. Thus, from a viewpoint of preventing a decrease of the opening ratio, the pretilt angle is preferably set to be in the above-described preferable range. In a case of the horizontal alignment film, the pretilt angle may be in a range which is used in a general horizontal alignment mode. The pretilt angle is preferably smaller than 10°. From a viewpoint of obtaining an effect of maintaining good contrast for a long term, the pretilt angle is more preferably 0°. In the horizontal alignment mode, it is possible to widen a viewing angle by reducing the pretilt angle.

The photo-alignment film 40 contains at least one alignment film polymer which has an ester group (—COO—). An ester group is easily decomposed by moisture infiltrated into the liquid crystal panel. Thus, if a low-molecule component is separated from the alignment film polymer by this decomposition, and is eluted into the liquid crystal layer 30, display poorness is caused. In the embodiment, the low-molecule component is captured by the second bonding functional group on the surface of the photo-alignment film and thus elution into the liquid crystal layer 30 is prevented. The ester group may be included in the main chain of the alignment film polymer or may be included in the side chain thereof. The type of the alignment film polymer contained in the photo-alignment film 40 may be one type or may be two types or more. In a case where two types or more of alignment film polymers are used, all of the alignment film polymers may have an ester group, or an alignment film polymer having an ester group and another alignment film polymer which does not have an ester group may be used together. An ester group has an advantage in that the ester group can be formed without generating a by-product which functions as impurities at a synthesis stage. Regarding a polymer in which the main chain is linked by an ester bond, the degree of polymerization is relatively easily increased. Thus, it is easy to increase the molecular weight of the polymer. Thus, it is possible to suppress elution of a low-molecule component in the photo-alignment film 40 into the liquid crystal layer 30, by using the alignment film polymer having an ester group.

The ester group may be included in the photo-functional group which will be described later, and may be included at a part other than the photo-functional group. Among photo-functional groups, a cinnamate group, a coumarin group, and a phenol ester group include an ester group. Specific examples of the photo-functional group including an ester group include compounds represented by Formulas (4) to (9), (33), and (34) which will be described later. Specific examples of the part including an ester group, other than the photo-functional group include compounds represented by Formulas (10) and (11) which will be described later. The ester group is also formed by a reaction of an epoxy (glycidyl) group and —COOH. For example, the ester group is also generated by a reaction of a compound represented by Formula (2) or (3) with compounds represented by Formulas (4) to (9), (33), (34), and (H-1) to (H-6).

Further, the alignment film polymer included in the photo-alignment film 40 includes a photo-alignment film polymer. The photo-alignment film polymer has at least one photo-functional group selected from the group consisting of a cinnamate group, a chalconyl group, an azobenzene group, a coumarin group, a stilbene group, and a phenol ester group. A cinnamate group, a coumarin group, and a phenol ester group are functional groups including an ester group. Thus, the second bonding functional group in the embodiment is suitably used in a case where a cinnamate group, a coumarin group, and a phenol ester group are used as the photo-functional group. The photo-functional group may be included in the main chain of the photo-alignment film polymer or may be included in a side chain thereof.

The photo-alignment film polymer exhibits photo-aligning characteristics by irradiation with light. “Exhibiting photo-aligning characteristics” means that a reaction such as dimerization (dimer formation), isomerization, and photo Fries transition or a structure change is caused by irradiation with light (electromagnetic wave) such as ultraviolet light and visible light, and thus properties of regulating alignment of liquid crystal molecules provided in the vicinity of the polymer are exhibited or the size and/or the orientation of an anchoring force is changed.

A cinnamate group indicated by the following Formula (B-1), a chalconyl group indicated by the following Formulas (B-2-1) and (B-2-2), a coumarin group indicated by the following Formula (B-3), and a stilbene group indicated by the following Formula (B-4) are dimerized and isomerized by irradiation with light. An isomerization reaction and a dimerization reaction of a cinnamate group are shown in the following Formula (B-1-I).

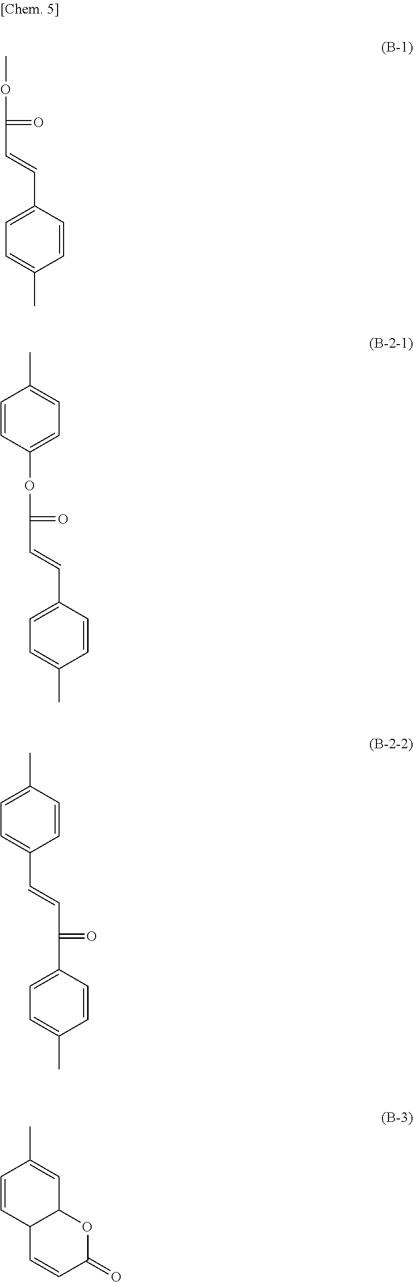

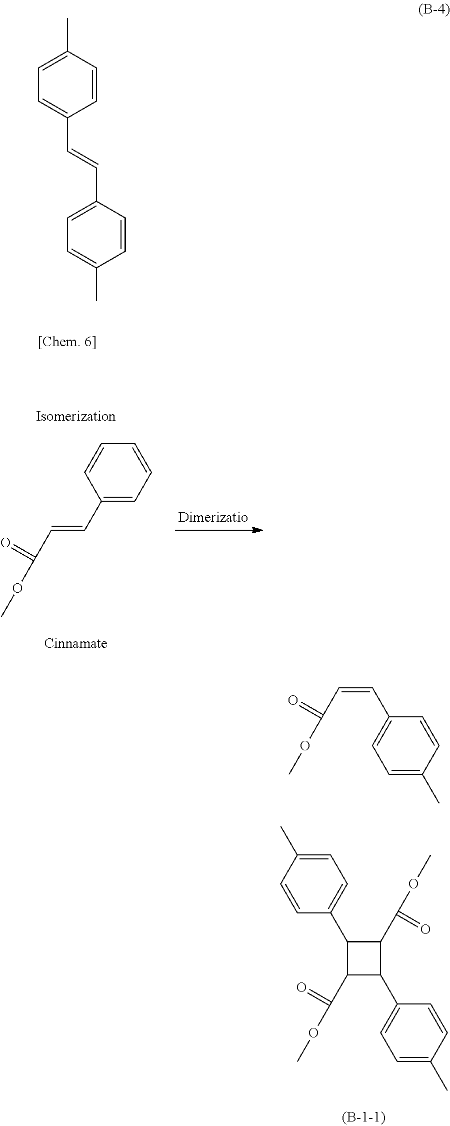

An azobenzene group is isomerized by irradiation with light. A trans body of azobenzene is shown in the following Formula (B-5-1). A cis body of azobenzene is shown in the following Formula (B-5-2).

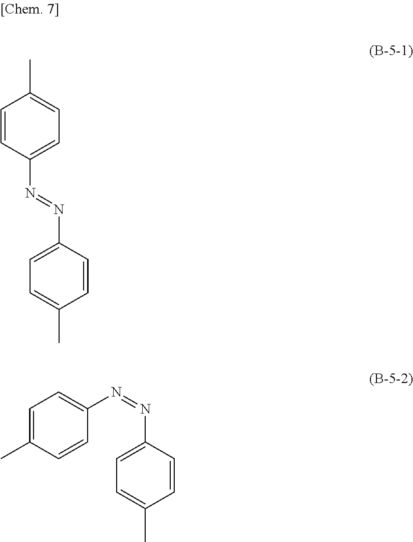 [SMILES: Cc1ccc(/N=N/c2ccc(C)cc2)cc1 ; Cc1ccc(/N=N\c2ccc(C)cc2)cc1]

A phenol ester group shown in the following Formula (B-6) is subjected to photo Fries transition by irradiation with light, as indicated by the following Formula (B-6-I).

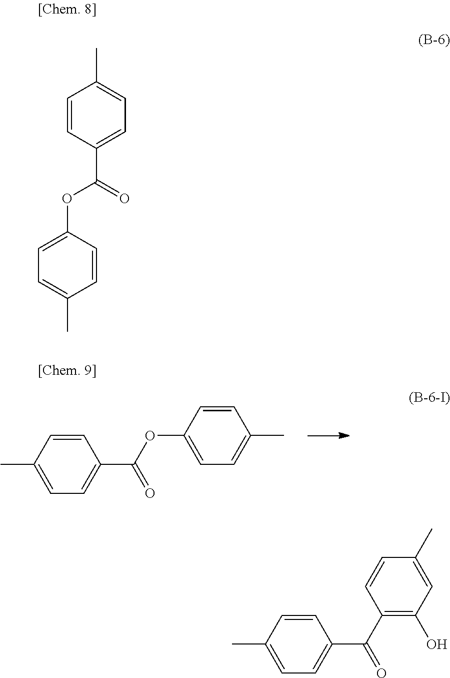

In the embodiment, at least one second bonding functional group which is selected from the group consisting of —COOH, —NH₂, —NHR (R indicates an aliphatic or alicyclic hydrocarbon having 1 to 18 carbon atoms, or indicates a structure in which a hydroxyl group and/or a halogen group is added to the hydrocarbon), —SH, and —OH is provided on the surface of the photo-alignment film 40. The phrase that the second bonding functional group is provided on the surface of the photo-alignment film 40 means that the second bonding functional group is provided in the photo-alignment film 40 in the vicinity (portion positioned at a distance of 10 nm or less from an interface) of the interface which is in contact with the liquid crystal layer 30 or the sealing material 50). The second bonding functional group may be provided as much as can be detected by an analysis method such as ¹H, ¹³C-NMR, mass analysis, and Fourier-transform infrared spectroscopy (FT-IR). Among second bonding functional groups, in particular, —COOH (carboxyl group) exhibits reactivity with an epoxy group or a silane coupling agent at a relatively low temperature.

As a method of providing the second bonding functional group on the surface of the photo-alignment film 40, for example, a method of causing the second bonding functional group to be included in a side chain of the alignment film polymer can be used. A method of causing the second bonding functional group to be disposed at the terminal of the side chain of the alignment film polymer (on an opposite side of the main chain) is suitable. In a case where the photo-alignment film 40 is a vertical alignment film, an alignment film polymer having a side chain is suitably used. Thus, in order to provide the second bonding functional group on the surface of the vertical alignment film, it is preferable that the second bonding functional group is included in a side chain for inducing vertical alignment. It is more preferable that the second bonding functional group is included at the terminal of the side chain for inducing vertical alignment. In a case where the photo-alignment film 40 is a horizontal alignment film, an alignment film polymer which does not have a side chain or an alignment film polymer in which the content of the side chain is small is suitably used. Thus, even when the second bonding functional group is provided in the vicinity of the main chain, it is possible to provide the second bonding functional group on the surface of the photo-alignment film 40.

The second bonding functional group is provided on the surface of the photo-alignment film 40, and thus the first bonding functional group included in the sealing resin which is the material of the sealing material 50 can be chemically bonded to the second bonding functional group. Thus, it is possible to improve adhesive strength between the photo-alignment film 40 and the sealing material 50. As a result, an effect of preventing infiltration of moisture from the interface between the photo-alignment film 40 and the sealing material 50 into the liquid crystal layer 30 is obtained. This will be described below with reference to FIGS. 4 to 6.

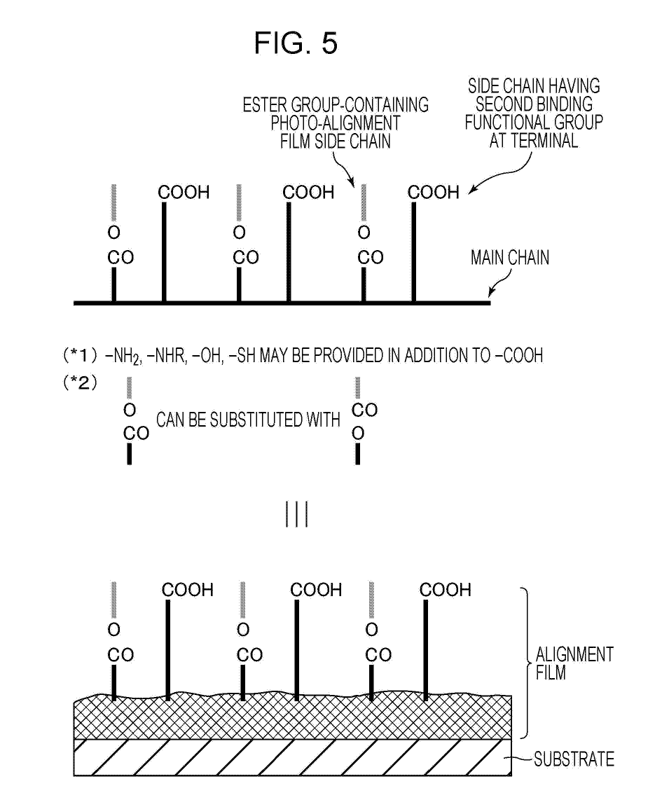

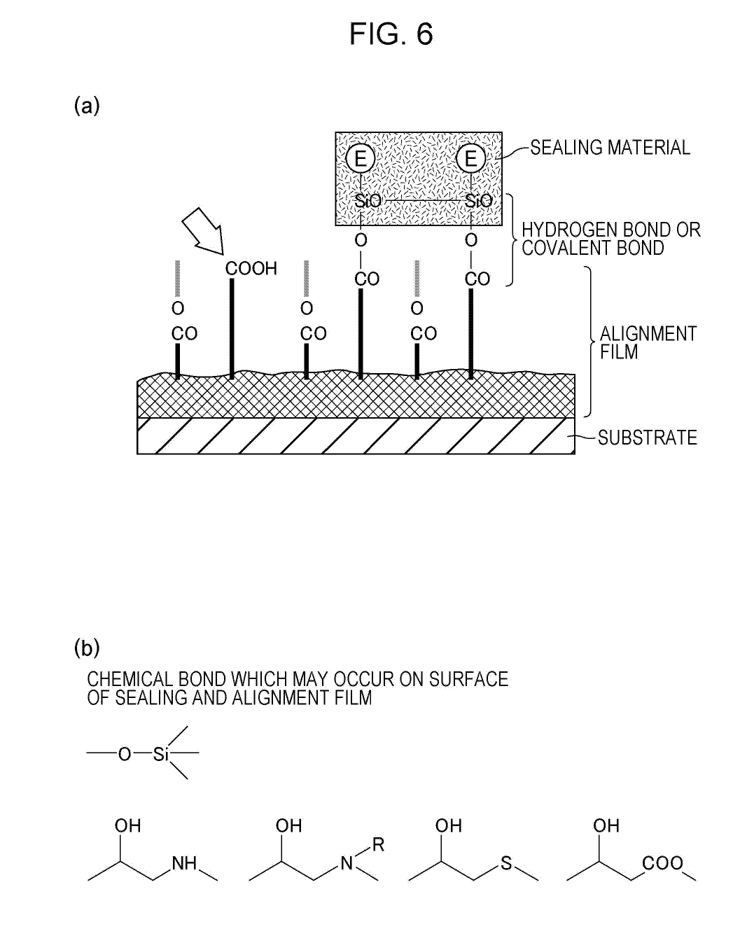

FIG. 4 is a schematic diagram illustrating a surface state of an alignment film in the related art, which uses an alignment film polymer in which the main chain is formed of polyamic acid and a second bonding functional group is not given to the terminal of a side chain. FIG. 5 is a schematic diagram illustrating a surface state of a photo-alignment film in the embodiment, which uses an alignment film polymer in which the second bonding functional group is given to the terminal of the side chain. FIG. 6(a) is a schematic diagram illustrating an adhesion state between the photo-alignment film and a sealing material in the embodiment, and FIG. 6(b) illustrates an example of a chemical bond formed at an interface between the photo-alignment film and the sealing material in the embodiment. As illustrated in FIG. 4, the side chain of a photo-alignment film including an ester group which is easily decomposed by moisture is provided on the surface of the photo-alignment film in the related art. As illustrated in FIG. 5, the side chain which includes the second bonding functional group at the terminal, not a side chain of a photo-alignment film, which includes an ester group, is provided on the surface of the photo-alignment film in the embodiment. Thus, according to the photo-alignment film 40 in the embodiment, a hydrogen bond or a covalent bond (see FIG. 6(a)) can be formed between the second bonding functional group and a methoxy(ethoxy) silane group of a silane coupling agent included in the sealing material 50, and thus it is possible to suppress infiltration of moisture. A hydrogen bond or a covalent bond (see FIG. 6(b)) can also be formed between the second bonding functional group and an epoxy group included in the sealing material 50, and thus it is possible to suppress infiltration of moisture. As a chemical bond formed between the photo-alignment film 40 and the sealing material 50, various bonds illustrated in FIG. 6(b) are exemplified in accordance with the type of the second bonding functional group.

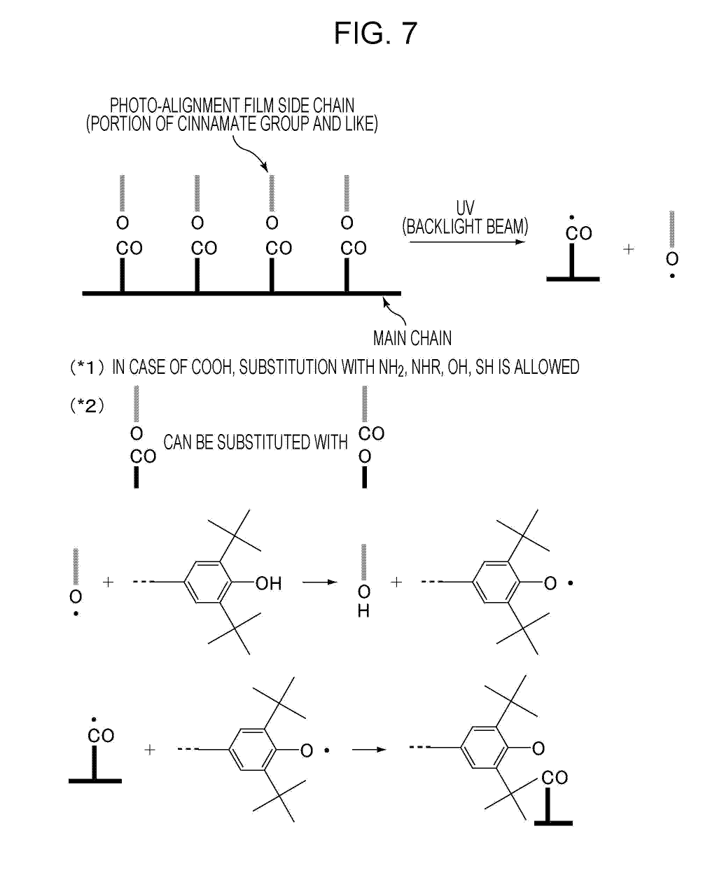

The second bonding functional group is provided on the surface of the photo-alignment film 40, and thus an effect of preventing irreversible consumption of the antioxidant in the liquid crystal layer 30 is also obtained. This will be described below with reference to FIGS. 7 to 9.

FIG. 7 is a diagram illustrating an action of an antioxidant on the alignment film in the related art, which uses the alignment film polymer in which the second bonding functional group is not given to the terminal of the side chain. As illustrated in FIG. 7, in a case where a radical pair is generated from the side chain of the photo-alignment film, which includes an ester group, radicals in the alignment film polymer may be chemically bonded to radicals of the antioxidant on the surface of the alignment film in the related art. Thus, the antioxidant may be consumed. As described above, if the antioxidant is consumed, the concentration of the antioxidant in the liquid crystal layer 30 is decreased with time and finally, oxidation of liquid crystal occurs.

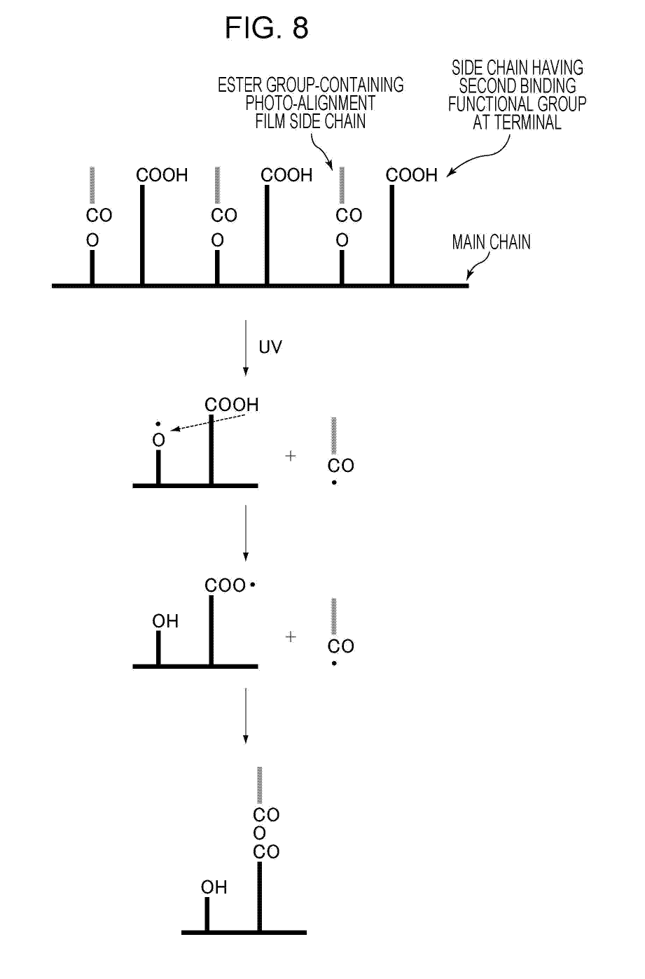

FIG. 8 is a diagram illustrating an action of the second bonding functional group in the alignment film in the embodiment. As illustrated in FIG. 8, a side chain of the photo-alignment film, which includes an ester group, and a side chain which includes the second bonding functional group (—COOH) at the terminal thereof are provided together on the surface of the photo-alignment film 40 in the embodiment. Thus, in a case where a radical pair is generated from the side chain of the photo-alignment film, which includes an ester group, for example, by irradiation with ultraviolet light (UV), a side chain which includes the second bonding functional group at the terminal reacts with the radical pair. That is, a hydrogen radical (H.) separated from —COOH is bonded to a radical of the radical pair on the alignment film polymer side. A radical (—COO.) on the alignment film polymer side, which is generated by separation of the hydrogen radical is bonded to a radical of the radical pair, which has been separated from the alignment film polymer. As a result, it is possible to prevent elution of a low-molecule component into the liquid crystal layer 30 and to prevent a decrease of the VHR without consuming the antioxidant.

FIG. 8 illustrates —COOH as the second bonding functional group. However, even in a case of being substituted with —NH₂, —NHR, —SH, and —OH, the similar effect is obtained.

FIG. 8 illustrates an example in which the side chain of the photo-alignment film, which includes ester group reacts with the side chain which includes the second bonding functional group at the terminal, in the same molecule. However, the side chain of the photo-alignment film, which includes ester group involved in the reaction, and the side chain which includes the second bonding functional group at the terminal may be provided in molecules which are different from each other.

Further, regarding the alignment film polymer in the embodiment, in a case where the side chain including an epoxy group is further introduced into the alignment film polymer, crosslinking between alignment film polymers is possible, and thus it is possible to effectively prevent elution into the liquid crystal layer 30. That is, as the alignment film polymer, a polymer which has a side chain including an epoxy group is suitably used.

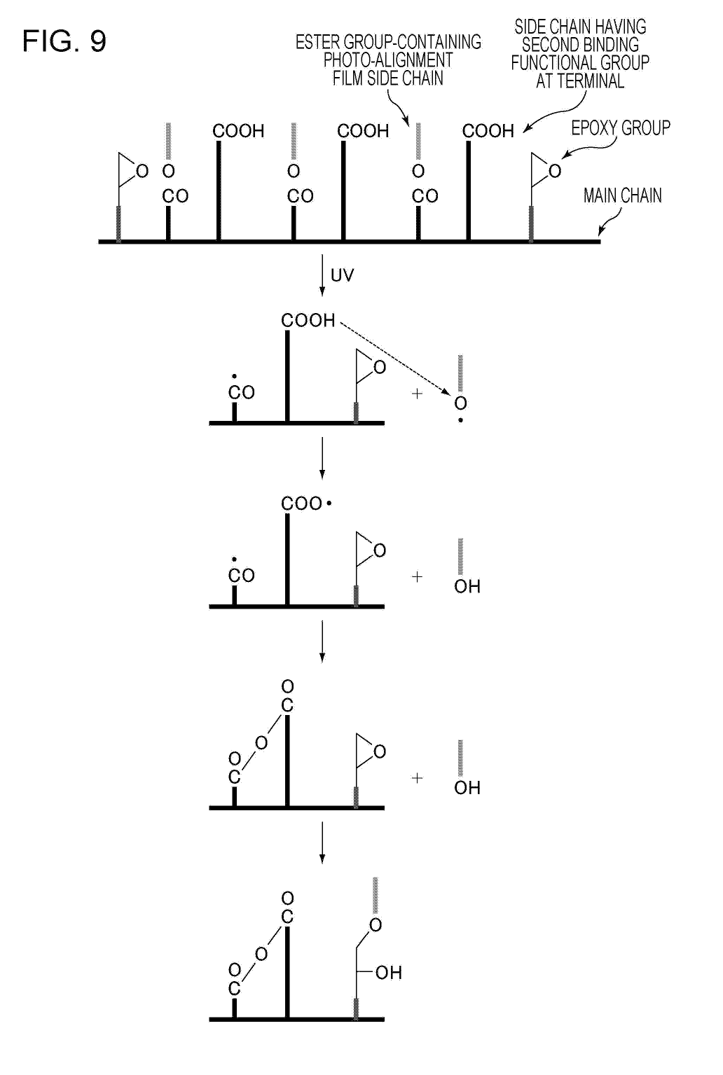

In a case where the alignment film polymer in the embodiment has a side chain including an epoxy group, it is also possible to deactivate a radical pair generated by cleaving the side chain of the photo-alignment film, which includes an ester group, by a reaction mechanism other than a reaction mechanism illustrated in FIG. 8. FIG. 9 is a diagram illustrating an action of the second bonding functional group in the photo-alignment film in the embodiment when the side chain including an epoxy group is provided. If an epoxy group is further provided on the surface of the photo-alignment film 40, as illustrated in FIG. 9, in a case where a radical pair is generated from the side chain of the photo-alignment film, which includes an ester group, a hydrogen radical (H.) separated from —COOH is bonded to a radical of the radical pair, which is separated from the alignment film polymer, so as to generate a low-molecule component having a hydroxyl group (—OH). In addition, a radical (—COO.) on the alignment film polymer side, which is generated by separation of the hydrogen radical is bonded to the radical of the radical pair on the alignment film polymer side. Further, the low-molecule component having the hydroxyl group thermally reacts with an epoxy group, and thus is bonded to the alignment film polymer. As a result, it is possible to prevent elution of a low-molecule component into the liquid crystal layer 30 and to prevent a decrease of the VHR without consuming the antioxidant.

FIG. 9 illustrates —COOH as a hydrogen-bonding functional group. However, even in a case of being substituted with —NH₂, —NHR, —SH, and —OH, the similar effect is obtained.

FIG. 9 illustrates an example in which the side chain of the photo-alignment film, which includes ester group reacts with the side chain which includes the second bonding functional group at the terminal, in the same molecule. However, the side chain of the photo-alignment film, which includes ester group involved in the reaction, and the side chain which includes the second bonding functional group at the terminal may be provided in molecules which are different from each other.

Further, according to the side chain which includes an epoxy group, crosslinking between alignment film polymers is possible. Thus, it is possible to effectively prevent elution into the liquid crystal layer 30.

The structure of the main chain of the alignment film polymer is not particularly limited. For example, polysiloxane, polyacryl, polymethacryl, and polyvinyl are exemplified. Among the substances, polysiloxane is suitable. Polysiloxane is used for the structure of the main chain, and thus it is possible to obtain an alignment film having excellent heat resistance. In a case where two types or more of alignment film polymers are used, the structure of the main chain of the alignment film polymer may be the same as each other or be different from each other.

A preferred form of the alignment film polymer will be described. The preferred form is classified into (A) a case where one type of a photo-alignment film polymer includes an ester group, a photo-functional group, and a second bonding functional group, and (B) a case where a photo-alignment film polymer (first component) which includes an ester group and a photo-functional group and an alignment film polymer (second component) which includes a second bonding functional group are used together. In the case of (A), the photo-alignment film 40 may contain an alignment film polymer which is different from the one type of the photo-alignment film polymer. In the case of (B), the photo-alignment film 40 may contain an alignment film polymer which is different from the first component and the second component.

In the case of (A), a photo-alignment film polymer which has a main chain having a polysiloxane structure and a side chain combined to the main chain is suitably used. In the photo-alignment film polymer, the side chain includes an ester group, the photo-functional group, the second bonding functional group, and an epoxy group. Here, the ester group, the photo-functional group, the second bonding functional group, and the epoxy group may be contained in one side chain branched from the main chain or may be respectively contained in side chains which are different from each other. The ester group may be included in a side chain which is the same as a side chain which includes the photo-functional group, or may be included in a side chain which is different from the side chain which includes the photo-functional group. The second bonding functional group is preferably positioned at the terminal of the side chain. The number of second bonding functional groups included in each one side chain which includes the second bonding functional group may be one, two, or three or more.

The photo-alignment film polymer can be obtained as a product obtained by causing polysiloxane (also referred to as “reactive polysiloxane”) which does not include an ester group, the photo-functional group, and the second bonding functional group in a side chain to react with at least one compound for forming a side chain.

<Reactive Polysiloxane>

As the reactive polysiloxane, a substance having a repetitive unit represented by the following Formula (1) is exemplified.

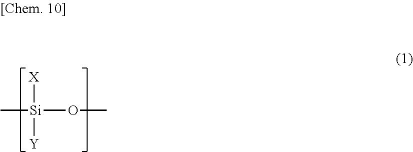

X in Formula (1) is not particularly limited, and is preferably a group configured to include an epoxy group. Examples of such a group include a group represented by the following Formula (2) and a group represented by the following Formula (3).

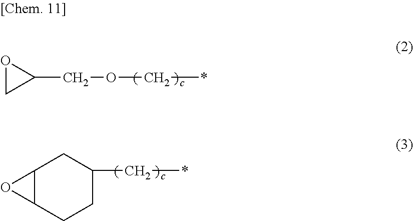 [SMILES: *COCC1CO1 ; *CC1CCC2OC2C1]

c in Formulas (2) and (3) indicates an integer of 1 to 10. “*” each indicates that a bond portion having “*” is bonded to a silicon atom. For example, an epoxy group in X reacts with a reactive portion of the compound for forming a side chain, such as a carboxyl group. Thus, the photo-alignment film polymer is generated. That is, it is preferable that the photo-alignment film polymer has a structure derived from an epoxy group, at at least one portion thereof. The structure derived from an epoxy group is formed by causing an epoxy group included in the reactive polysiloxane to react with a reactive portion of the compound for forming a side chain. An alicyclic epoxy compound such as a group represented by Formula (3) easily reacts with acid.

Y in Formula (1) is not particularly limited. Examples of Y include a hydroxyl group, an alkoxyl group having 1 to 10 carbon atoms, an alkyl group having 1 to 6 carbon atoms, and an aryl group having 6 to 10 carbon atoms. As a preferable example of Y, a hydroxyl group and an alkoxyl group having 1 to 10 carbon atoms are exemplified. More specifically, a methoxyl group and an ethoxyl group are exemplified.

The reactive polysiloxane can be acquired as a commercial product or can be obtained in a manner that methods defined in organic chemistry are appropriately combined so as to perform synthesis. As a method of producing the reactive polysiloxane, the producing method disclosed in PTL 4 may be used.

<Compound for Forming Side Chain>

As the compound for forming a side chain, a compound including the photo-functional group and a compound including the second bonding functional group are suitably used. The compound including the photo-functional group may be singly used or may be used in combination of two types or more thereof. Similarly, the compound including the second bonding functional group may be singly used or may be used in combination of two types or more thereof.

Examples of the compound including the photo-functional group include a compound having a chemical structure which is represented by the following Formula (4), and a compound having a chemical structure which is represented by the following Formula (8).

R¹—C₆H₄—COO—C₆H₄—CH═CH—COOH (4)

In Formula (4), R¹ indicates a fluorine-containing group which has 1 to 20 carbon atoms. —COOH on the right side can be bonded to an epoxy group and the like included in X in Formula (1), and thus form a side chain.

Examples of the fluorine-containing group which has 1 to 20 carbon atoms in R¹ include a fluoroalkyl group such as a trifluoromethyl group, a perfluoroethyl group, a 3,3,3-trifluoropropyl group, a 4,4,4-trifluorobutyl group, a 4,4-5,5,5-pentafluoropentyl group, and a 4,4-5,5-6,6,6-heptafluorohexyl group.

Preferred examples of the compound represented by Formula (4) include compounds represented by the following Formulas (5), (6), and (7).

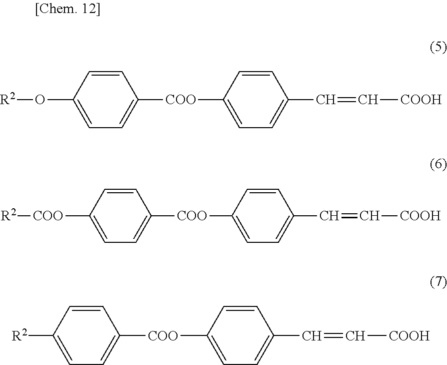

In Formulas (5), (6), and (7), R² indicates a fluoroalkyl group having 1 to 10 carbon atoms.

R³—R⁴—COO—C₆H₄—CH═CH—COOH (8)

In Formula (8), R³ indicates an alkyl group having 4 to 10 carbon atoms, and R⁴ indicates a group obtained by leaving two hydrogen atoms from alicyclic hydrocarbon having 6 to 10 carbon atoms. —COOH on the right side can be bonded to an epoxy group and the like included in X in Formula (1), and thus form a side chain.

Examples of the alkyl group having 4 to 10 carbon atoms in R³ include an n-butyl group, an n-pentyl group, an n-hexyl group, an n-octyl group, and an n-decyl group.

Examples of the alicyclic hydrocarbon having 6 to 10 carbon atoms in R⁴ include saturated hydrocarbon (cycloalkane) such as cyclohexane, cycloheptane, and cyclooctane; and unsaturated hydrocarbon such as cycloalkene and cycloalkyne. The alicyclic hydrocarbon may be monocyclic or polycyclic.

Preferred examples of the compound represented by Formula (8) include a compound represented by the following Formula (9).

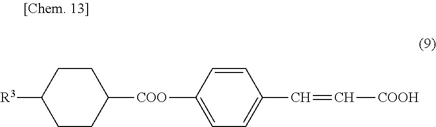

In Formula (9), R³ indicates an alkyl group having 4 to 10 carbon atoms.

The compound including the photo-functional group has a structure represented by C₆H₄—CH═CH—CO. Thus, it is possible to exhibit an anchoring force by a photo-alignment method.

The compound including the photo-functional group can be acquired as a commercial product or can be obtained in a manner that methods defined in organic chemistry are appropriately combined so as to perform synthesis. As a method of producing the compound which includes the photo-functional group, the producing method disclosed in PTL 4 may be used.

Examples of the compound including the second bonding functional group include compounds represented by the following Formulas (H-1), (H-2), (H-3), (H-4), (H-5), and (H-6).

Z—(C₆H₄)ₙ—COOH (H-1)

Z₂—(C₆H₃)—(C₆H₄)ₙ₋₁—COOH (H-2)

Z—(C₆H₁₀)ₙ—COOH (H-3)

Z₂—(C₆H₉)—(C₆H₁₀)ₙ₋₁—COOH (H-4)

Z—(C₁₀H₆)—COOH (H-5)

Z₂—(C₁₀H₅)—COOH (H-6)

In Formulas (H-1), (H-2), (H-3), (H-4), (H-5), and (H-6), Z indicates the second bonding functional group (—COOH, —NH₂, —NHR, —SH, or —OH). C₆H₄ or C₆H₃ represents a phenylene group. C₆H₁₀ or C₆H₉ represents a cyclohexylene group. C₁₀H₆ or C₁₀H₅ represents a naphthyl group. n indicates 1 or 2. —COOH on the right side can react with an epoxy group and the like included in X in Formula (1), and thus form a side chain.

As the compound including the second bonding functional group, compounds represented by the following Formulas (H-a) and (H-b) are suitable. —COOH on the right side in the following Formulas (H-a) and (H-b) can react with an epoxy group and the like included in X in Formula (1), and thus form a side chain.

[Chem. 14]

Z-A¹P-A²ₙCOOH (H-a)

(in Formula (H-a), Z indicates the second bonding functional group. A¹ and A² are the same as each other or different from each other, and indicate 1,4-phenylene, 1,3-phenylene, 1,2-phenylene, 1,4-cyclohexylene, 1,3-cyclohexylene, or 1,2-cyclohexylene. P indicates —COO—, —OCO—, —O—, —CONH—, —NHCO—, or direct bonding. n indicates 0, 1, or 2.)

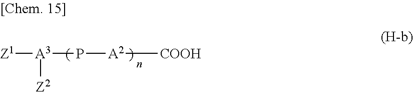

(in Formula (H-b), Z¹ and Z² indicate the second bonding functional group of the same or different type. A³ indicates 1,2,3-phenylene, 1,2,4-phenylene, 1,3,4-phenylene, 1,2,3-cyclohexylene, 1,2,4-cyclohexylene, or 1,3,4-cyclohexylene. P indicates —COO—, —OCO—, —O—, —CONH—, —NHCO—, or direct bonding. A² indicates 1,4-phenylene, 1,3-phenylene, 1,2-phenylene, 1,4-cyclohexylene, 1,3-cyclohexylene, or 1,2-cyclohexylene. n indicates 0, 1, or 2.)

The content of the side chain including the second bonding functional group is preferably more than 0 mol % and 40 mol % or more with respect to silicon atoms included in the main chain. Thus, the mixed amount of the compound including the second bonding functional group is preferably set to be more than 0 mol % and 40 mol % or more, with respect to the number of moles of silicon atoms included in the reactive polysiloxane. The content and the mixed amount thereof are set to be more than 0 mol % and 40 mol % or more, and thus it is possible to sufficiently exhibit an advantageous effect of improving adhesive strength at an interface between the sealing material 50 and the photo-alignment film 40, and an advantageous effect of reducing the consumed amount of the antioxidant. As a result, it is possible to sufficiently suppress the longitudinal decrease of the VHR. If the content and the mixed amount thereof are more than 40 mol %, a compound having high polarity is put into the photo-alignment film 40 at a panel manufacturing stage, and thus an initial VHR may be reduced. Regarding the content of the side chain including the second bonding functional group, a more preferable range is 5 mol % to 25 mol % with respect to the silicon atoms included in the main chain.

(Production Reaction of Photo-Alignment Film Polymer)

The reactive polysiloxane is caused to react with the compound for forming the side chain, thereby the photo-alignment film polymer is obtained. Other compounds in addition to the compound including the photo-functional group or the compound including the second bonding functional group may be caused to react with the reactive polysiloxane, so as to form a side chain.

A production reaction of the photo-alignment film polymer is preferably performed under providing a catalyst. As the catalyst, for example, an organic base, or a compound which is well-known as a so-called curing accelerator for accelerating a reaction of an epoxy group and a carboxyl group can be used.

The production reaction can be performed, if necessary, under providing an organic solvent. As the organic solvent, for example, an ether compound, an ester compound, a ketone compound are preferably from a viewpoint of solubility of a raw material and a product, and easy purification of the product.

In the case (A) where one type of the photo-alignment film polymer includes an ester group, the photo-functional group, and the second bonding functional group, features of the preferred form of the liquid crystal display device in the embodiment are as follows.

(A1) Photo-Alignment Film

The photo-functional group and an ester group are provided in a side chain of polysiloxane and the second bonding functional group is provided at the terminal of another side chain. Further, the following (A1-1), (A1-2), (A1-3), and (A1-4) are satisfied.

(A1-1)

At least one of components constituting the photo-alignment film is formed of a side chain including the photo-functional group in the main chain of polysiloxane and a side chain including ester group at the center portion thereof. The side chain including the photo-functional group and the side chain including ester group at the center portion thereof are the same as each other or different from each other.

(A1-2)

In at least one of components constituting the photo-alignment film, at least one type of side chain including the photo-functional group which causes liquid crystal molecules to be substantially vertically or substantially horizontally aligned is bonded to the main chain of polysiloxane. A fluorine atom is provided at the tip of one or both of the side chain including the photo-functional group and the side chain including an ester group at the center portion thereof. Further, the total content of the side chain including the photo-functional group and the side chain including an ester group at the center portion thereof is less than 50 mol % with respect to silicon atoms in the main chain of polysiloxane. As the photo-alignment film, a film which causes liquid crystal to be substantially vertically (tilt angle: 86° or greater and smaller than 90°) aligned is particularly preferable.

(A1-3)

As another side chain, a side chain which includes one or two second bonding functional groups at the terminal thereof is provided. In the side chain, a compound of the following Formula (H-1), (H-2), (H-3), (H-4), (H-5), or (H-6) is bonded to an epoxy (glycidyl) group.

Z—(C₆H₄)ₙ—COOH (H-1)

Z₂—(C₆H₃)—(C₆H₄)ₙ₋₁—COOH (H-2)

Z—(C₆H₁₀)ₙ—COOH (H-3)

Z₂—(C₆H₉)—(C₆H₁₀)ₙ₋₁—COOH (H-4)

Z—(C₁₀H₆)—COOH (H-5)

Z₂—(C₁₀H₅)—COOH (H-6)

In Formulas (H-1), (H-2), (H-3), (H-4), (H-5), and (H-6), Z indicates the second bonding functional group, and n indicates 1 or 2.

(A1-4)

As the photo-functional group, at least one of cinnamate, azobenzene, coumarin, chalcone, stilbene, and phenol ester is included. In particular, cinnamate and phenol ester are suitable.

(A2) Sealing Material

A sealing resin cured by ultraviolet light or visible light, and heat is suitable.

(A3) Liquid Crystal Layer

A negative liquid crystal composition to which an antioxidant is added is contained.

In the case (B) where a photo-alignment film polymer (first component) including an ester group and the photo-functional group, and an alignment film polymer (second component) including the second bonding functional group are used together, the first component has a main chain of a polysiloxane structure and a side chain combined to the main chain. As the side chain, a side chain which includes the ester group, the photo-functional group, and an epoxy group is suitably used. Here, the ester group, the photo-functional group, and the epoxy group may be contained in one side chain branched from the main chain or may be respectively contained in side chains which are different from each other. The ester group may be included in a side chain which is the same as a side chain which includes the photo-functional group, or may be included in a side chain which is different from the side chain which includes the photo-functional group.

The first component can be obtained as a product obtained by causing polysiloxane which does not include an ester group and the photo-functional group in a side chain, to react with at least one compound for forming a side chain. As polysiloxane which does not include an ester group and the photo-functional group in a side chain, the above-described reactive polysiloxane can be used. For example, a substance which has a repetitive unit represented by Formula (1) is exemplified. As the compound for forming a side chain, a compound which includes the above-described photo-functional group is suitably used. For example, a compound having a chemical structure represented by Formula (4) and a compound having a chemical structure which is represented by the following Formula (8) are exemplified. As the compound including the photo-functional group, only one type of a compound may be used or plural types of compounds may be used.

As the second component, polysiloxane, polyacryl, polymethacryl, and polyvinyl which have the second bonding functional group are suitably used. As the second bonding functional group, in a case of polyacryl and polymethacryl, —COOH which is originally included can be used. Addition may be performed by causing a reaction with the compound including the second bonding functional group, such as the compounds represented by Formulas (H-1), (H-2), (H-3), (H-4), (H-5), and (H-6). As the compound including the second bonding functional group, only one type of a compound may be used or plural types of compounds may be used. The second bonding functional group is preferably positioned at the terminal of the side chain. The number of second bonding functional groups included in each one side chain which includes the second bonding functional group may be one, two, or three or more.

A mixing ratio (also referred to as “a modification ratio” below) of the first component in the photo-alignment film is preferably more than 5 weight % with respect to the total amount of the first component and the second component. If the modification ratio is equal to or less than 5 weight %, a compound having high polarity is put into the photo-alignment film 40 at a panel manufacturing stage, and thus an initial VHR may be reduced and screen image sticking may occur. The modification ratio is preferably less than 50 weight % with respect to the total amount of the first component and the second component. If the modification ratio is equal to or more than 50 weight %, adhesive strength between the sealing material 50 and the photo-alignment film 40 is degraded, and thus surrounding stain may occur by moisture infiltrated from an outside thereof. The modification ratio is more preferably less than 30 weight %.

In the case (B) where a photo-alignment film polymer (first component) including an ester group and the photo-functional group, and an alignment film polymer (second component) including the second bonding functional group are used together, features of the first preferred form of the liquid crystal display device in the embodiment are as follows.

(Ba1) Photo-Alignment Film

The first component is polysiloxane having photo-aligning characteristics. The second component is a polymer having carboxylic acid. The following Formulas (Ba1-1), (Ba1-2), (Ba1-3), (Ba1-4), (Ba1-5), (Ba1-6), and (Ba1-7) are satisfied.

(Ba1-1)

A component constituting the photo-alignment film is formed of at least two components of the first component and the second component.

(Ba1-2)

In the first component, a side chain including the photo-functional group, and a side chain including an ester group at the center portion thereof are bonded to the main chain of polysiloxane. The side chain including the photo-functional group and the side chain including ester group are the same as each other or different from each other.

(Ba1-3)

In at least one of components constituting the photo-alignment film, at least one type of the side chain including the photo-functional group which causes liquid crystal molecules to be substantially vertically or substantially horizontally aligned is bonded to the main chain of polysiloxane, which is the first component. A fluorine atom is provided at the tip of one or both of the side chain including the photo-functional group and the side chain including an ester group at the center portion thereof. As the photo-alignment film, a film which causes liquid crystal to be substantially vertically (tilt angle: 86° or greater and smaller than 90°) aligned is particularly preferable.

(Ba1-4)

As still another side chain, a side chain having an epoxy (glycidyl) group is provided.

(Ba1-5)

The second component is formed from polysiloxane, polyacryl, polymethacryl, and polyvinyl which have at least one type of the second bonding functional group at the terminal.

(Ba1-6)

Regarding a ratio of the first component and the second component, the first component is set to be more than 5 weight % and less than 30 weight %. In order to prevent the decrease of the initial VHR and prevent an occurrence of screen image sticking, the content of the first component is set to be more than 5 weight %. In order to sufficiently distribute at least one type of the second bonding functional group on the surface of the photo-alignment film, the content of the first component is set to be less than 30 weight %.

(Ba1-7)

As the photo-functional group, at least one of cinnamate, azobenzene, coumarin, chalcone, stilbene, and phenol ester is included. In particular, cinnamate and phenol ester are suitable.

(Ba2) Sealing Material

A sealing resin cured by ultraviolet light or visible light, and heat is suitable.

(Ba3) Liquid Crystal Layer

A negative liquid crystal composition to which an antioxidant is added is contained.

In the case (B) where a photo-alignment film polymer (first component) including an ester group and the photo-functional group, and an alignment film polymer (second component) including the hydrogen-bonding functional group are used together, polyamic acid having an imidization ratio being less than 90% is also suitably used as the second component. Polyamic acid in the second component may be formed only of one type of polyamic acid, and may be formed of two types or more of polyamic acid. The polyamic acid can be obtained by causing tetracarboxylic acid dianhydride and diamine to react with each other.

Examples of tetracarboxylic acid dianhydride used in synthesis of polyamic acid include 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-(tetrahydro-2,5-dioxo-3-furanyl)-8-methyl-naphtho[1,2-c]-furan-1,3-dione, 2,3,5-tricarboxycyclopentyl acetic acid dianhydride, butane tetracarboxylic dianhydride, 1,3-dimethyl-1,2,3,4-cyclobutanetetracarboxylic dianhydride, 1,2,3,4-cyclobutanetetracarboxylic dianhydride, pyromellitic dianhydride, 3,3′,4,4′-biphenylsulfone tetracarboxylic dianhydride, 1,4,5,8-naphthalenetetracarboxylic dianhydride, 2,3,6,7-naphthalenetetracarboxylic dianhydride, and 3,3′,4,4′-biphenyl ether tetracarboxylic dianhydride. The tetracarboxylic acid dianhydride can be singly used or can be used in combination of two types or more thereof.

Examples of diamine which is allowed to be used in synthesis of polyamic acid can include p-phenylenediamine, 4,4′-diaminodiphenylmethane, 1,5-diaminonaphthalene, 2,7-diaminofluorene, 4,4′-diaminodiphenyl ether, 4,4′-(p-phenyleneisopropylidene) bisaniline, 2,2-bis[4-(4-aminophenoxy)phenyl]hexafluoropropane, 2,2-bis(4-aminophenyl)hexafluoropropane, 2,2-bis[4-(4-amino-2-trifluoromethylphenoxy)phenyl] hexafluoropropane, 4,4′-diamino-2,2′-bis(trifluoromethyl)biphenyl, 4,4′-bis[(4-amino-2-trifluoromethyl)phenoxy]-octafluorobiphenyl, 1-hexadecyloxy-2,4-diaminobenzene, 1-octadecyloxy-2,4-diaminobenzene, 1-cholesteryloxy-2,4-diaminobenzene, 1-cholestanyloxy-2,4-diaminobenzene, hexadecyloxy(3,5-diaminobenzoyl), octadecyloxy(3,5-diaminobenzoyl), cholesteryloxy(3,5-diaminobenzoyl), cholestanyloxy(3,5-diaminobenzoyl), and diamine represented by each of the following Formulas (10) to (13). In the following Formula (13), y indicates an integer of 2 to 12. The diamine can be singly used or can be used in combination of two types or more thereof.

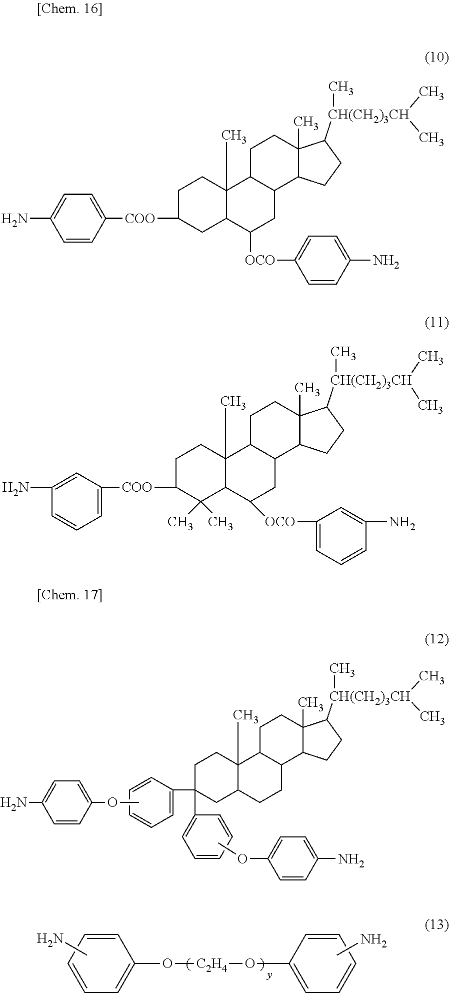

The synthesis reaction of polyamic acid is preferably performed in an organic solvent. A reaction solution itself obtained by dissolving polyamic acid may be provided for preparing a liquid crystal aligning agent. The reaction solution may be provided for preparing the liquid crystal aligning agent, in a state where polyamic acid included in the reaction solution is isolated. In addition, the reaction solution may be provided for preparing the liquid crystal aligning agent, in a state where the isolated polyamic acid is purified.

The amount (which is less than 90%) of an amic acid structure included in polyamic acid which has been obtained in the above-described manner is cyclodehydrated so as to perform imidization. Thus, a partially-imidized matter in which the amic acid structure (10% or more) and an imide structure (less than 90%) are provided together is obtained.

Cyclodehydration of polyamic acid is performed by (i) a method of heating polyamic acid and (ii) a method in which a dehydrating agent and a cyclodehydration catalyst are added to a solution obtained by dissolving polyamic acid in an organic solvent, and, if necessary, heating is performed.

The partially-imidized matter itself obtained by the method (i) may be provided for preparing a liquid crystal aligning agent. The partially-imidized matter may be provided for preparing a liquid crystal aligning agent, in a state where the obtained partially-imidized matter is purified. In the method (ii), a reaction solution which contains the partially-imidized matter is obtained. The reaction solution itself may be provided for preparing a liquid crystal aligning agent. The reaction solution may be provided for preparing a liquid crystal aligning agent, in a state where a dehydrating agent and a cyclodehydration catalyst are removed from the reaction solution. The reaction solution may be provided for preparing a liquid crystal aligning agent, in a state where the partially-imidized matter is isolated. The reaction solution may be provided for preparing a liquid crystal aligning agent, in a state where the isolated partially-imidized matter is purified. For example, a method of substitution of a solvent can be applied in order to remove the dehydrating agent and the cyclodehydration catalyst from the reaction solution.

The mixing ratio (modification ratio) of the first component in the photo-alignment film is preferably more than 5 weight % with respect to the total amount of the first component and the second component. If the modification ratio is equal to or less than 5 weight %, a compound having high polarity is put into the photo-alignment film 40 at a panel manufacturing stage, and thus an initial VHR may be reduced and screen image sticking may occur. The modification ratio thereof is preferably less than 30 weight % with respect to the total amount of the first component and the second component. If the modification ratio is equal to or more than 30 weight %, adhesive strength between the sealing material 50 and the photo-alignment film 40 is degraded, and thus surrounding stain may occur by moisture infiltrated from an outside thereof. The modification ratio is more preferably less than 25 weight %.

In the case (B) where a photo-alignment film polymer (first component) including an ester group and the photo-functional group, and an alignment film polymer (second component) including the second bonding functional group are used together, features of the second preferred form of the liquid crystal display device in the embodiment are as follows.

(Bb1) Photo-Alignment Film

The first component is polysiloxane having photo-aligning characteristics. The second component is polyamic acid. The following Formulas (Bb1-1), (Bb1-2), (Bb1-3), (Bb1-4), (Bb1-5), (Bb1-6), and (Bb1-7) are satisfied.

(Bb1-1)

A component constituting the photo-alignment film is formed of at least two components of the first component and the second component.

(Bb1-2)

In the first component, a side chain including the photo-functional group, and a side chain including an ester group at the center portion thereof are bonded to the main chain of polysiloxane. The side chain including the photo-functional group and the side chain including ester group are the same as each other or different from each other.

(Bb1-3)

In at least one of components constituting the photo-alignment film, at least one type of the side chain including the photo-functional group which causes liquid crystal molecules to be substantially vertically or substantially horizontally aligned is bonded to the main chain of polysiloxane, which is the first component. A fluorine atom is provided at the tip of one or both of the side chain including the photo-functional group and the side chain including an ester group at the center portion thereof. As the photo-alignment film, a film which causes liquid crystal to be substantially vertically (tilt angle: 86° or greater and smaller than 90°) aligned is particularly preferable.

(Bb1-4)

As still another side chain, a side chain having an epoxy (glycidyl) group is provided.

(Bb1-5)

The second component is formed of polyamic acid having an imidization ratio being less than 90%.

(Bb1-6)

Regarding a ratio of the first component and the second component, the first component is set to be more than 5 weight % and less than 25 weight %. In order to prevent the decrease of the initial VHR and prevent an occurrence of screen image sticking, the content of the first component is set to be more than 5 weight %. In order to sufficiently distribute —COOH (carboxylic acid) on the surface of the photo-alignment film, the content of the first component is set to be less than 25 weight %.

(Bb1-7)

As the photo-functional group, at least one of cinnamate, azobenzene, coumarin, chalcone, stilbene, and phenol ester is included. In particular, cinnamate and phenol ester are suitable.

(Bb2) Sealing Material

A sealing resin cured by ultraviolet light or visible light, and heat is suitable.

(Bb3) Liquid Crystal Layer

A negative liquid crystal composition to which an antioxidant is added is contained.

<Other Component of Alignment Film Polymer>

The photo-alignment film 40 may further contain other components in addition to the alignment film polymer. As other components, a substance derived from a certain component in a liquid crystal aligning agent which will be described later is exemplified.

### [Liquid Crystal Aligning Agent]

As described above, a liquid crystal aligning agent which is a material of the alignment film contains the alignment film polymer. However, if necessary, the liquid crystal aligning agent may contain any other components. Preferably, the liquid crystal aligning agent is prepared as a composition liquid in which the components are dissolved in an organic solvent.

Examples of any other components can include a crosslinking agent (curing agent), a curing catalyst, a polymer other than the alignment film polymer, a compound in which at least one oxiranyl group is provided in a molecule, a functional silane compound, and a surfactant.

The curing agent and the curing catalyst respectively cause crosslinking of the alignment film polymer to be more firm. The curing agent and the curing catalyst can be contained in the liquid crystal aligning agent, in order to more improve strength of the photo-alignment film 40. In a case where the liquid crystal aligning agent contains the curing agent, a curing accelerator may be used together.

As the curing agent, a curable compound which includes an epoxy group, or a curing agent which is generally used for curing the curable compound which includes an epoxy group can be used. Examples of such a curing agent include polyvalent amine, polycarboxylic acid anhydride, polycarboxylic acid, and polycarboxylic acid ester. Specific examples of polycarboxylic acid include cyclohexane-1,2,4-tricarboxylic acid, cyclohexane-1,3,5-tricarboxylic acid, cyclohexane-1,2,3-tricarboxylic acid, benzene-1,2,4-tricarboxylic acid, and naphthalene-1,2,4-tricarboxylic acid. Examples of cyclohexane tricarboxylic anhydride can include cyclohexane-1,3,4-tricarboxylic acid-3,4-anhydride, cyclohexane-1,3,5-tricarboxylic acid-3,5-anhydride, cyclohexane-1,2,3-tricarboxylic acid-2,3-anhydride, 4-methyltetrahydrophthalic anhydride, methylnadic anhydride, and dodecenylsuccinic anhydride.

The polymer other than the alignment film polymer can be used for more improving solution characteristics of the liquid crystal aligning agent and electrical characteristics of the obtained photo-alignment film 40.

The compound in which at least one oxiranyl group is provided in a molecule can be contained in the liquid crystal aligning agent, from a viewpoint of more improving adhesiveness of the obtained photo-alignment film 40 to the surface of the substrate.

The functional silane compound can be used for improving adhesiveness of the obtained photo-alignment film 40 to the substrate.

As an organic solvent which can be used for preparing the liquid crystal aligning agent, a solvent which dissolves the alignment film polymer or the material thereof, and any other components which are arbitrarily used, and does not react with these substances is preferable. The organic solvent can be singly used or can be used in combination of two types or more thereof. Examples of the preferable organic solvent include a solvent mixture which contains a solvent such as γ-butyl lactone (BL), N-methyl pyrrolidone (NMP), butyl cellosolve (BC), diethyl ether dibutyl glycol (DEDG), and dipentyl ether (DPE).

A proportion of the solid content concentration of the liquid crystal aligning agent (that is, the weight of all components other than the solvent in the liquid crystal aligning agent) which occupies in the total weight of the liquid crystal aligning agent is selected considering viscosity, volatility, and the like. The proportion is preferably in a range of 1 to 10 weight %. The liquid crystal aligning agent is applied onto the surface of the substrate, and thus forms a coating film which functions as the photo-alignment film 40. However, in a case where the solid content concentration is less than 1 weight %, the film thickness of the coating film is too small, and thus it may be difficult to obtain a good photo-alignment film 40. In a case where the solid content concentration is more than 10 weight %, the film thickness of the coating film is too thick, and thus, it may be difficult to obtain a good photo-alignment film 40. In addition, viscosity of the liquid crystal aligning agent is increased, and thus coating characteristics may be insufficient. A particularly preferable range of the solid content concentration varies depending on a method of coating the substrate with the liquid crystal aligning agent. In a case of an ink jet method, it is preferable that the solid content concentration is set to be in a range of 1 to 5 weight %, and solution viscosity is set to be in a range of 3 to 15 mPa·s. In a spinner method, a range of 1.5 to 4.5 weight % is preferable. In a case of a printing method, it is preferable that the solid content concentration is set to be in a range of 3 to 9 weight %, and the solution viscosity is set to be in a range of 12 to 50 mPa·s.

### [Film Formation Method of Photo-Alignment Film]

The liquid crystal display device according to the embodiment includes the photo-alignment film 40 which is formed from the liquid crystal aligning agent as described above. The liquid crystal aligning agent is applied onto the substrate, and then heating is performed to form a coating film. Then, the coating film is irradiated with light, so as to perform alignment treatment. Thus, the photo-alignment film 40 can be formed from the liquid crystal aligning agent. Examples of a coating method include a roll coater method, a spinner method, a printing method, and an ink jet method. The heating may be performed at two stages of preliminary heating (pre-baking) and firing (post-baking). The film thickness of the coating film is preferably equal to or more than 10 nm, more preferably equal to or more than 40 nm, further preferably equal to or more than 45 nm, particularly preferably equal to or more than 50 nm. The film thickness of the coating film is preferably equal to or less than 300 nm, more preferably equal to or less than 150 nm, further preferably equal to or less than 145 nm, and particularly preferably equal to or less than 140 nm.

As light used in the alignment treatment, linearly polarized light and unpolarized light can be used. For example, an ultraviolet ray and a visible ray which include light having a wavelength of 150 nm to 800 nm can be used. An ultraviolet ray which includes light having a wavelength of 250 nm to 400 nm is preferable. In a case using linearly polarized light, irradiation may be performed from a direction which is perpendicular to the surface of the substrate, may be performed from an inclined direction for giving the pretilt angle, or may be performed in a manner of combination thereof. In a case of irradiation with unpolarized light, it is necessary that a direction of the irradiation is an inclined direction.

As a light source to be used, for example, a low-pressure mercury lamp, a high-pressure mercury lamp, a deuterium lamp, a metal halide lamp, an argon resonance lamp, a xenon lamp, and an excimer laser can be used. An ultraviolet ray having the preferable wavelength range can be obtained by means and the like in which the light source is used, for example, along with a filter, diffraction grating, and the like.

The quantity of radial rays which are used for the irradiation is preferably equal to or greater than 0.1 mJ/cm² and smaller than 1000 mJ/cm², and more preferably equal to or greater than 1 mJ/cm² and smaller than 200 mJ/cm².

### [Backlight Unit]

As illustrated in FIG. 1, in the liquid crystal display device according to the embodiment, a backlight 80 is disposed on the back surface side of the liquid crystal panel. The liquid crystal display device having such a configuration is generally referred to as a transmissive liquid crystal display device. The backlight 80 is not particularly limited as long as the backlight 80 emits light including visible light. The backlight 80 may emit light which includes only visible light or may emit light which includes both of visible light and ultraviolet light. The backlight 80 configured to emit white light is suitable used for allowing color display by the liquid crystal display device. As the type of the backlight 80, for example, a light-emitting diode (LED) is suitably used. In this specification, “the visible light” means light (electromagnetic wave) having a wavelength which is equal to or greater than 380 nm and smaller than 800 nm.

According to the embodiment, exposure to light of the backlight 80 is performed, and thus it is possible to deactivate radicals generated from the photo-alignment film 40, by the antioxidant. Thus, in a case where at least a portion of an emission spectrum of the backlight 80 overlaps at least a portion of an absorption spectrum of the ester group or the photo-functional group, the antioxidant can effectively perform the function.

### [Display Mode]

A display mode of the liquid crystal display device according to the embodiment is not particularly limited. For example, a horizontal alignment mode, a vertical alignment mode, and a twisted nematic (TN) mode can be used. Specific examples of the horizontal alignment mode include a fringe field switching (FFS) mode and an in-plane switching (IPS) mode. Specific examples of the vertical alignment mode include a vertical alignment twisted nematic (VATN) mode.

In the FFS mode, a structure (FFS electrode structure) of including an electrode plate, a slit electrode, and an insulating film is provided on at least one substrate, and an inclined electric field (fringe field) is formed in a liquid crystal layer which is adjacent to the substrate. Generally, the slit electrode, the insulating film, and the electrode plate are disposed in this order from the liquid crystal layer. As the slit electrode, for example, an electrode which includes a line-like opening portion (which has the entire circumference surrounded by the electrode) as a slit, or a comb-like electrode in which a plurality of comb teeth is provided and a line-like notch disposed between the comb teeth constitutes a slit can be used.

In the IPS mode, a pair of comb electrodes are provided on at least one substrate, and a horizontal electric field is formed in a liquid crystal layer which is adjacent to the substrate. As the pair of comb electrodes, for example, an electrode pair which includes a plurality of comb teeth, and is disposed to engage a plurality of comb teeth of one electrode with a plurality of comb teeth of another electrode can be used.

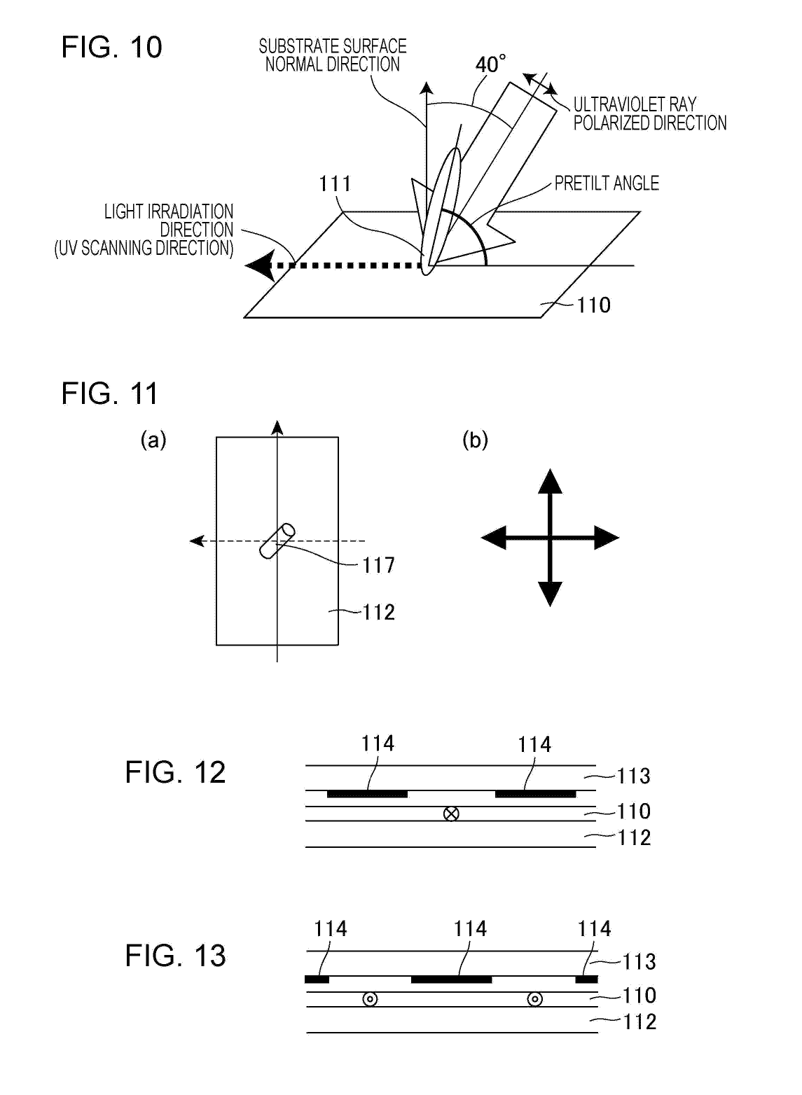

The VATN mode will be described below in detail with reference to FIGS. 10 to 14.

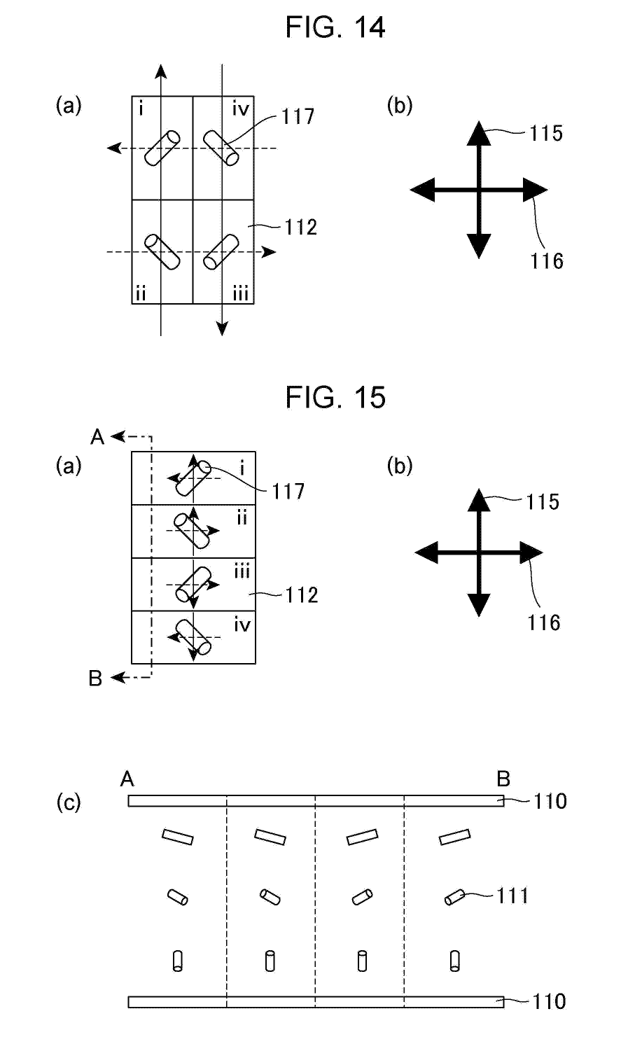

FIG. 10 is a schematic perspective view illustrating a relationship between a photo-alignment treatment direction and a pretilt direction of a liquid crystal molecule in the liquid crystal display device in the VATN mode. FIG. 11(a) is a schematic plan view illustrating a direction of an average liquid crystal director in one pixel (1 pixel or 1 subpixel) and a photo-alignment treatment direction with respect to a pair of substrates (upper and lower substrates), in a case where the liquid crystal display device in the VATN mode has a monodomain. FIG. 11(b) is a schematic diagram illustrating a direction of an absorption axis of a polarizer provided in the liquid crystal display device illustrated in FIG. 11(a). FIG. 11(a) illustrates a state where photo-alignment treatment directions are perpendicular to each other between the pair of substrates, and an AC voltage which is equal to or higher than a threshold is applied between the pair of substrates. In FIG. 11(a), a solid-line arrow indicates a light irradiation direction (photo-alignment treatment direction) for an upper substrate, and a dot-line arrow indicates a light irradiation direction (photo-alignment treatment direction) for a lower substrate. FIG. 12 is a schematic sectional view illustrating a first arrangement relationship between the substrate and a photomask in a photo-alignment treatment process for performing alignment division by a proximity exposure method using an alignment mask. FIG. 13 is a schematic sectional view illustrating a second arrangement relationship between the substrate and the photomask in the photo-alignment treatment process for performing alignment division by the proximity exposure method using the alignment mask. FIG. 14(a) is a schematic plan view illustrating a direction of an average liquid crystal director in one pixel (1 pixel or 1 subpixel), the photo-alignment treatment direction with respect to the pair of substrates (upper and lower substrates), and a division pattern for 4 domains, in a case where the liquid crystal display device has the 4 domains. FIG. 14(b) is a schematic diagram illustrating a direction of an absorption axis of a polarizer provided in the liquid crystal display device illustrated in FIG. 14(a). FIG. 14(a) illustrates a state where an AC voltage which is equal to or higher than a threshold is applied between the pair of substrates. In FIG. 14(a), a solid-line arrow indicates a light irradiation direction (photo-alignment treatment direction) for an upper substrate, and a dot-line arrow indicates a light irradiation direction (photo-alignment treatment direction) for a lower substrate.

In a VATN mode liquid crystal display device, a liquid crystal layer is interposed between a pair of substrates (upper and lower substrates), and the liquid crystal layer includes liquid crystal molecule having negative dielectric anisotropy. The pair of substrates includes an insulating transparent substrate formed of glass and the like. A transparent electrode is formed on each of surfaces of the pair of substrates, on a side adjacent to the liquid crystal layer. Further, the above-described photo-alignment film which exhibits vertical alignment characteristics is formed on each transparent electrode. The pair of substrates respectively functions as a driving element substrate (for example, TFT substrate) in which a driving element (switching element) is provided in each pixel (1 pixel or 1 subpixel), and a color filter substrate in which a color filter corresponding to each pixel in the driving element substrate is provided.

In the driving element substrate, the transparent electrode which has been connected to a driving element and been formed in a matrix functions as a pixel electrode. In the color filter substrate, the transparent electrode which has been uniformly formed on the entire surface of a display region functions as a counter electrode (common electrode). Further, a polarizer is disposed on each of surfaces of the pair of substrates on an opposite side of the side of the liquid crystal layer. The polarizer is disposed in a cross Nicole state. A cell thickness holding body (spacer) for holding a cell thickness to be constant is disposed at a predetermined position (non-display region) between the pair of substrates. The materials of the substrate and the transparent electrode, the material of the liquid crystal molecule, and the like are not particularly limited.

As illustrated in FIG. 10, if irradiation with an ultraviolet ray (UV light, a void arrow in FIG. 10) which is polarized to be parallel to an incident surface is performed at an inclination of 40° from a normal direction of the surface of the substrate, the photo-alignment film 110 can have a pretilt angle for the liquid crystal molecule 111 to the light irradiation direction side. Exposure of the photo-alignment film 110 may be performed by one-shot exposure or may be performed by scanning exposure. That is, the photo-alignment film 110 may be irradiated in a state where the substrate and a light source are fixed. In addition, as indicated by a dot-line arrow in FIG. 10, the photo-alignment film 110 may be irradiated with scanning of UV light along the light irradiation direction.

As illustrated in FIG. 11(a), when the substrate is viewed in a plan view, exposure of the photo-alignment film and adhering of the substrates are performed such that the light irradiation directions to the pair of substrates (upper and lower substrates 112) are substantially perpendicular to each other. Pretilt angles of liquid crystal molecules in the vicinity of the photo-alignment film provided on each of the upper and lower substrates 112 are substantially the same. A liquid crystal material which does not include a chiral material may be injected into the liquid crystal layer. In this state, if an AC voltage of a threshold or higher is applied between the upper and lower substrates 112, a liquid crystal molecule has a structure of being twisted in the normal direction of the surface of the substrate between the upper and lower substrates 112, by 90°. In addition, as illustrated in FIG. 11, when the substrate is viewed in a plan view, an average liquid crystal director direction 117 when the AC voltage is applied is an orientation of bisecting an angle of the light irradiation directions to the upper and lower substrates 112. As illustrated in FIG. 11(b), a direction of an absorption axis of a polarizer (upper polarizer) which is disposed on the upper substrate side coincides with the photo-alignment treatment direction of the upper substrate. A direction of an absorption axis of a polarizer (lower polarizer) which is disposed on the lower substrate side coincides with the photo-alignment treatment direction of the lower substrate.

Next, as illustrated in FIG. 14, a case where each pixel is subjected to alignment division in a liquid crystal display device will be described. In an exposure process for forming 4 domain in a liquid crystal display device, firstly, as illustrated in FIG. 12, a photomask 113 having a light shielding portion 114 which has a size of bisecting the width of one pixel in the liquid crystal display device is used, and thereby a region corresponding to the half of the one pixel is exposed in one direction (in FIG. 12, a depth direction from the front of the surface of paper), and the remaining half region is shielded by the light shielding portion 114. In the next step, as illustrated in FIG. 13, the photomask 113 is moved by about a half pitch of a pixel. The exposed region is shielded by the light shielding portion 114, and a not-shielded portion (not-exposed region in which exposure has not been performed in the step illustrated in FIG. 12) is exposed in a direction (in FIG. 13, the front direction from the inside of the paper) reverse to the direction in FIG. 12. Thus, regions in which liquid crystal pretilt is exhibited in directions reverse to each other are formed in a matrix, so as to bisect the width of one pixel in the liquid crystal display device.

As described above, alignment division is performed at an equal pitch, so as to bisect each pixel in each substrate. When the substrate is viewed in a plan view, both of the upper and lower substrates 112 are disposed (adhered to each other) so as to cause division directions (photo-alignment treatment directions) in the upper and lower substrates 112 to be perpendicular to each other. Further, the liquid crystal material which does not include a chiral material is injected into the liquid crystal layer. Thus, as illustrated in FIG. 14(a), an alignment direction of a liquid crystal molecule positioned in the vicinity of the center of the liquid crystal layer in a thickness direction thereof may be different in four regions (i to iv in FIG. 14(a)), more specifically, four divided domains which are substantially perpendicular to each other can be formed. That is, as illustrated in FIG. 14(a), when the substrate is viewed in a plan view, the average liquid crystal director direction 117 when the AC voltage is applied is an orientation of bisecting an angle of the light irradiation directions to the upper and lower substrates 112, in each of the domains. As illustrated in FIG. 14(b), when the substrate is viewed in a plan view, the photo-alignment treatment direction (solid-line arrow in FIG. 14(a)) of the upper substrate (color filter substrate) is the same direction as the direction 115 of the absorption axis of the polarizer disposed on the upper substrate side. The photo-alignment treatment direction (dot-line arrow in FIG. 14(a)) of the lower substrate (driving element substrate) is the same direction as the direction 116 of the absorption axis of the polarizer disposed on the lower substrate side.

In each domain boundary, an alignment direction of a liquid crystal molecule on one substrate coincides with the direction of the absorption axis of the polarizer, and an alignment direction of a liquid crystal molecule on the other substrate is substantially perpendicular to the substrate. Thus, in each domain boundary, in a case where the polarizer is disposed to be in a cross Nicol state, a dark line is formed because light is not transmitted even when a voltage is applied between the substrates.

As described above, in the VATN mode liquid crystal display device, in a case where four domains in which the alignment direction of a liquid crystal molecule is different (substantially perpendicular), it is possible to realize excellent viewpoint characteristics, that is, to realize a wide viewing angle.

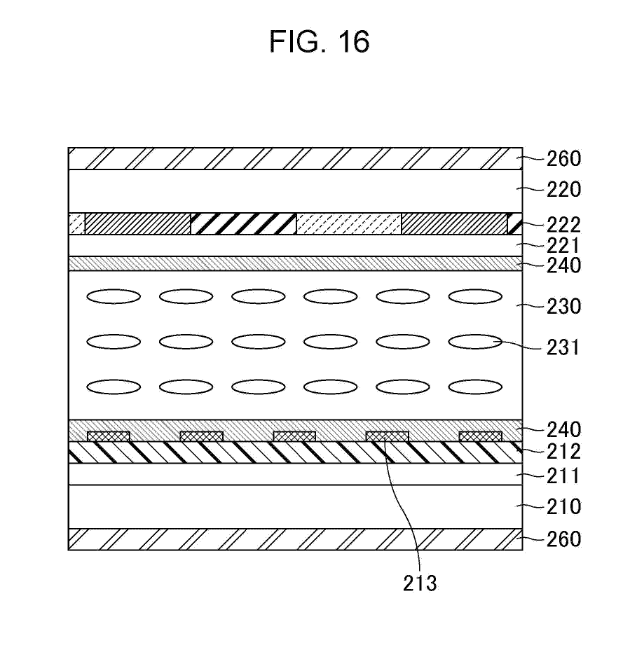

The layout of domains in the VATN mode liquid crystal display device is not limited to four-division as illustrated in FIG. 14(a), and may have a form as illustrated in FIG. 15(a). FIG. 15(a) is a schematic plan view illustrating a direction of an average liquid crystal director in one pixel (1 pixel or 1 subpixel), the photo-alignment treatment direction with respect to the pair of substrates (upper and lower substrates), and a division pattern for the other 4 domains, in a case where the liquid crystal display device has the other 4 domains. FIG. 15(b) is a schematic diagram illustrating a direction of an absorption axis of the polarizer provided in the liquid crystal display device illustrated in FIG. 15(a). FIG. 15(c) is a schematic sectional view illustrating a section taken along line A-B line in FIG. 15(a) when an AC voltage of a threshold or higher is applied between the pair of substrates. FIG. 15(c) illustrates alignment directions of liquid crystal molecules. In FIG. 15(a), a dot-line direction indicates a light irradiation direction (photo-alignment treatment direction) to the lower substrate, and a solid-line direction indicates a light irradiation direction (photo-alignment treatment direction) to the upper substrate. In FIG. 15(c), a dot line indicates a domain boundary.

As a method of producing the form in FIG. 15, firstly, as illustrated in FIG. 15(a), alignment division is performed at an equal pitch, so as to bisect each pixel in each substrate. When the substrate is viewed in a plan view, both of the upper and lower substrates 112 are disposed (adhered to each other) so as to cause division directions (photo-alignment treatment directions) in the upper and lower substrates 112 to be perpendicular to each other. Thus, as illustrated in FIG. 15(a), an alignment direction of a liquid crystal molecule positioned in the vicinity of the center of the liquid crystal layer in a thickness direction thereof may be different in four regions (i to iv in FIG. 15(a)), more specifically, four divided domains which are substantially perpendicular to each other can be formed. That is, as illustrated in FIG. 15(a), when the substrate is viewed in a plan view, the average liquid crystal director direction 117 when the AC voltage is applied is an orientation of bisecting an angle of the light irradiation directions to the upper and lower substrates 112, in each of the domains. As illustrated in FIG. 15(b), in this state, when the substrate is viewed in a plan view, the photo-alignment treatment direction (solid-line arrow in FIG. 15(a)) of the upper substrate (color filter substrate) is the same direction as the direction 115 of the absorption axis of the polarizer disposed on the upper substrate side. The photo-alignment treatment direction (dot-line arrow in FIG. 15(a)) of the lower substrate (driving element substrate) is the same direction as the direction 116 of the absorption axis of the polarizer disposed on the lower substrate side. When a voltage is not applied between the upper and lower substrates, liquid crystal molecules are aligned in a direction which is substantially perpendicular to the upper and lower substrates, by an anchoring force of the photo-alignment film. When a voltage of a threshold or higher is applied between the upper and lower substrates, as illustrated in FIG. 15(c), liquid crystal molecules 111 are twisted by about 90° between the upper and lower substrates, and four alignment states which are different from each other in the four domains are provided.

Hereinafter, the embodiment according to the present invention is described. All individual items which have been described may be applied to the whole of the present invention.

The present invention will be more specifically described below. Descriptions will be made by using synthesis examples and comparative synthesis examples which relate to the liquid crystal aligning agent, and by using examples and comparative examples which relate to the liquid crystal panel. However, the present invention is not limited to only the examples.

### SYNTHESIS EXAMPLE 1 TO 5 AND COMPARATIVE SYNTHESIS EXAMPLE 1

A polymer in which a first side chain, a second side chain, and a third side chain were bonded to reactive polysiloxane was prepared. As the reactive polysiloxane, a compound in which X indicates a 2-(3,4-epoxycyclohexyl)ethyl group and Y indicates a methoxy group in the following Formula (1) was used.

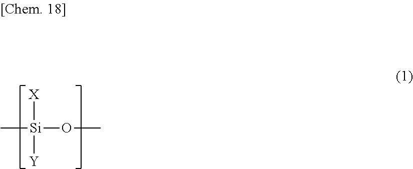

As the first side chain, a group represented by the following Formula (33) including the photo-functional group was used. As the second side chain, a group represented by the following Formula (34) including the photo-functional group was used. As the second side chain, a group which included a carboxyl group (—COOH) and was represented by the following Formula (H-1-1) was used.

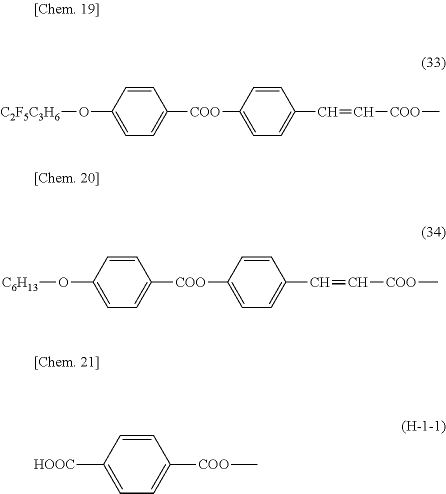

The content of the first side chain was set to 15 mol % with respect to silicon atoms included in the main chain (reactive polysiloxane) of siloxane, and the content of the second side chain was set to 25 mol % with respect to the silicon atoms included in the main chain of siloxane (total content 40 mol %). The content of the third side chain was 0 mol % (Comparative Synthesis Example 1), 10 mol % (Synthesis Example 1), 20 mol % (Synthesis Example 2), 30 mol % (Synthesis Example 3), 40 mol % (Synthesis Example 4), or 50 mol % (Synthesis Example 5) with respect to the silicon atoms included in the main chain of siloxane. Synthesis Examples 1 to 5 are the same as each other except that the content of the third side chain is different from each other.

As understood from the content, at least one of X and Y in Formula (1) remained in the prepared polymer.

Liquid crystal aligning agents in Synthesis Example 1 to 5 were prepared by dissolving a solid component which was formed from the polymer, in a solvent. As the solvent, a solvent mixture obtained by mixing NMP (N-methylpyrrolidone) and BC (ethylene glycol monobutyl ether, butyl cellosolve) at a weight ratio of 1:1 was used. The concentration of the solid component was set to 3.0 weight %.

Liquid crystal aligning agents in Synthesis Example 1 to 5 and Comparative Synthesis Example 1 were prepared in the above-described manner. The liquid crystal aligning agents were a material for a vertical alignment film, and could be applied to photo-alignment treatment.

### EXAMPLES 1 TO 5 AND COMPARATIVE EXAMPLE 1

Liquid crystal panels in Examples 1 to 5 and Comparative Example 1 were respectively manufactured by using the liquid crystal aligning agents in Synthesis Examples 1 to 5 and Comparative Synthesis Example 1, in accordance with the following procedures (1) to (6).

(1) A glass substrate (TFT substrate) which had a TFT element and an indium-tin-oxide (ITO) transparent electrode was prepared, and a glass substrate (color filter substrate) which had a black matrix, a color filter, a photospacer, and an ITO transparent electrode was prepared.

(2) The liquid crystal aligning agent was applied onto surfaces of both of the washed substrates on the transparent electrode side by an ink jet method. Then, drying was performed at 80° C. for 2 minutes. Then, firing was performed at 230° C. in a nitrogen atmosphere for 40 minutes, thereby a film having a film thickness of 100 nm was manufactured.

(3) The surface of each of the substrates was irradiated with an ultraviolet ray which was linearly polarized light having a wavelength of 313 nm, an extinction ratio of 10:1, and energy of 20 mJ/cm². The irradiation was performed as alignment treatment, from a direction which was inclined from a normal line of the substrate by 40°. With the irradiation, an alignment film was obtained. When irradiation with an ultraviolet ray being linearly polarized light was performed, the alignment treatment was performed by using a photomask, so as to form four domains in each pixel.

(4) An UV-curable and thermosetting sealing agent were applied on one substrate by using a dispenser. The UV-curable and thermosetting sealing agent was formed of an acrylic resin, an epoxy resin, an epoxy curing agent, a photopolymerization initiator, a silane coupling agent, and an inorganic and organic filler. As the silane coupling agent, 3-glycidoxypropyltrimethoxysilane (manufactured by Shin-Etsu Chemical Co., Ltd., brand name: SHIN-ETSU SILICONES (registered trademark), product name: KBM403) was used. A negative type liquid crystal composition was dropped to a predetermined position on the other substrate. The negative type liquid crystal composition included 50 to 500 ppm of a dibutylhydroxyphenyl compound as an antioxidant. A pair of substrates was disposed to form four domains in each pixel, and was adhered to each other under vacuum. Further, the sealing agent on the adhered substrate was cured by ultraviolet light, thereby a liquid crystal panel was obtained.

(5) The obtained liquid crystal panel was heated at 130° C. so as to perform re-alignment treatment of liquid crystal.

(6) A pair of polarizers disposed to be in crossed Nicols state were disposed to sandwich the liquid crystal panel. The polarizers were disposed to cause a polarization axis thereof to coincide with an irradiation direction in which the photo-alignment film was irradiated with an ultraviolet ray. As a result, a liquid crystal panel was completed.

A liquid crystal driving circuit and a backlight were attached to the liquid crystal panel in each of Examples 1 to 5 and Comparative Example 1, and a test of preservation-on-backlight was performed under the following high-temperature and high-humidity condition.

The backlight turned ON, and the voltage holding ratio (VHR) was measured before and after the backlight was left at 50° C. and humidity of 90% for 500 hours. The VHR was measured under conditions of 1 V and 70° C., by using the 6254 type VHR measurement system manufactured by Toyo Corporation.

Display (backlight ON) of a black and white pattern was performed at 50° C. and humidity of 90% for 500 hours. Then, an occurrence status of screen image sticking and surrounding stain when halftone display was performed was confirmed. Screen image sticking occurs by deterioration of liquid crystal or the alignment film and by an influence of moisture infiltration. Surrounding stain was evaluated by observing the vicinity of the sealing material in the liquid crystal panel. Surrounding stain occurs by moisture infiltration from an interface between the sealing material and the photo-alignment film.

Evaluation results of the liquid crystal panels in Examples 1 to 5 and Comparative Example 1 were collectively shown in the following Table 1.

TABLE 1

| | Third side | VHR (%) | | Liquid crystal panel observation | |
|---|---|---|---|---|---|
| | chain | | After | Screen image | Surrounding |
| | (mol %) | Initial | 500 hs | sticking | stain |
| Comparative | 0 | 99.5 | 91 | Significant | Significant |
| Example 1 | | | | occurrence | occurrence |
| Example 1 | 10 | 99.5 | 97.5 | Occurrence | Occurrence |
| Example 2 | 20 | 99.5 | 99.3 | None | None |
| Example 3 | 30 | 99.5 | 98.5 | None | None |
| Example 4 | 40 | 98.1 | 96.5 | Slight | None |
| | | | | occurrence | |
| Example 5 | 50 | 97.3 | 94.2 | Occurrence | None |

In Comparative Example 1 (content of third side chain: 0 mol %), the VHR was greatly decreased after the panel had been left for 500 hours, and it was observed that screen image sticking and surrounding stain obviously occurred. It is considered that the reason is because moisture infiltration from the interface between the sealing material and the photo-alignment film or deterioration of the photo-alignment film and liquid crystal has significantly occurred. It is considered that deterioration of the photo-alignment film and the liquid crystal occurs due to that a cinnamate group of the photo-alignment film has been cleaved by backlight light, and thus an antioxidant in liquid crystal has been consumed.

In Example 1 (content of third side chain: 10 mol %), after the panel had been left for 500 hours, the decrease of the VHR and the occurrence of screen image sticking and surrounding stain were observed. However, all of the degree of the decrease of the VHR and the degree of the occurrence of screen image sticking and surrounding stain were improved in comparison to those in Comparative Example 1.

In Examples 2 and 3 (content of third side chain: 20 and 30 mol %), after the panel had been left for 500 hours, the VHR was hardly decreased, and the degree of the occurrence of screen image sticking and surrounding stain was also significantly improved. The reason is because of contribution of both effects. One is that —COOH was introduced at the terminal in the photo-alignment film, and thus it was possible to improve adhesiveness to the sealing material, and to hinder moisture infiltration from the outside of the liquid crystal panel. The other is that —COOH effectively captured a cinnamate group cleaved by backlight light, and thus the antioxidant in the liquid crystal was not consumed. In Examples 2 and 3, contrast of 5000 or more was ensured even after the panel had been left for 500 hours.

In Examples 4 and 5 (content of third side chain: 40 and 50 mol %), surrounding stain was not observed, but screen image sticking was observed. As the cause, it is considered that the content of —COOH is increased, and thus an initial VHR before the panel is left for 500 hours is reduced. As the cause of reducing the initial VHR, there is a probability of an occurrence of a case where, since carboxylic acid has high polarity, a compound having high polarity, such as moisture or an ionic component is taken in at a stage of manufacturing the panel.

### SYNTHESIS EXAMPLES 6 TO 10 AND COMPARATIVE SYNTHESIS EXAMPLE 2

A liquid crystal aligning agent was prepared in a manner similar to that in Synthesis Examples 1 to 5 and Comparative Synthesis Example 1, except that a group represented by the following Formula (H-2-1) in which two carboxyl groups were provided was used as the third side chain. The content of the third side chain in Synthesis Examples 6 to 10 and Comparative Synthesis Example 2 was 0 mol % (Comparative Synthesis Example 2), 10 mol % (Synthesis Example 6), 20 mol % (Synthesis Example 7), 30 mol % (Synthesis Example 8), 40 mol % (Synthesis Example 9), or 50 mol % (Synthesis Example 10), with respect to silicon atoms included in the main chain (reactive polysiloxane) of siloxane.

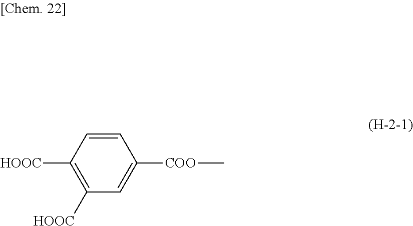

### EXAMPLES 6 TO 10 AND COMPARATIVE EXAMPLE 2

Liquid crystal panels in Examples 6 to 10 and Comparative Example 2 were respectively manufactured by using the liquid crystal aligning agents in Synthesis Examples 6 to 10 and Comparative Synthesis Example 2, in a manner similar to that in Example 1. A test of preservation-on-backlight was performed on the liquid crystal panels in Examples 6 to 10 and Comparative Example 2, under the following high-temperature and high-humidity condition in a manner similar to that in Example 1. Test results were collectively shown in the following Table 2.

TABLE 2

| | Third side | VHR (%) | | Liquid crystal panel observation | |
|---|---|---|---|---|---|
| | chain | | After | Screen image | Surrounding |
| | (mol %) | Initial | 500 hs | sticking | stain |
| Comparative | 0 | 99.5 | 91.0 | Significant | Significant |
| Example 2 | | | | occurrence | occurrence |
| Example 6 | 10 | 99.5 | 99.2 | None | None |
| Example 7 | 20 | 99.5 | 98.8 | None | None |
| Example 8 | 30 | 98.3 | 97.6 | Slight | None |
| | | | | occurrence | |
| Example 9 | 40 | 97.5 | 95.0 | Occurrence | None |
| Example 10 | 50 | 93.3 | 92.0 | Occurrence | None |

In Comparative Example 2 (content of third side chain: 0 mol %), similarly to Comparative Example 1, the VHR was greatly decreased after the panel had been left for 500 hours, and it was observed that screen image sticking and surrounding stain obviously occurred.

In Example 6 (content of third side chain: 10 mol %), after the panel had been left for 500 hours, the VHR was hardly decreased, and the screen image sticking and the surrounding stain were not viewed. The third side chain included in the photo-alignment film in Example 6 included two —COOH in one side chain. Thus, an effect higher than that in Example 1 in which the content of the third side chain was the same as that in Example 6 was obtained. In Example 7 (content of third side chain: 20 mol %), similarly to Example 6, it was also possible to suppress the decrease of the VHR and the occurrence of screen image sticking and surrounding stain. In Examples 6 and 7, contrast of 5000 or more was ensured even after the panel had been left for 500 hours.

In Examples 8, 9, and 10 (content of third side chain: 30, 40, and 50 mol %), similarly to Examples 4 and 5, surrounding stain was not observed, but screen image sticking was observed. As the cause, it is considered that the content of —COOH is increased, and thus an initial VHR before the panel is left for 500 hours is reduced.

### COMPARATIVE EXAMPLES 3 AND 4

Liquid crystal panels in Comparative Examples 3 and 4 were respectively manufactured in a manner similar to that in Example 2 and Comparative Example 1, except that a compound which did not contain an antioxidant was used as the negative type liquid crystal composition. A test of preservation-on-backlight was performed on the liquid crystal panels in Comparative Examples 3 and 4, under the following high-temperature and high-humidity condition in a manner similar to that in Example 1. Evaluation results of the liquid crystal panels in Example 2 and Comparative Examples 1, 3, and 4 were collectively shown in the following Table 3.

TABLE 3

| | Third | | | | Liquid crystal panel | |
|---|---|---|---|---|---|---|
| | side | | | | observation | |
| | chain | | VHR (%) | | Screen | Sur- |
| | (mol | Anti- | In- | After | image | rounding |
| | %) | oxidant | itial | 500 hs | sticking | stain |
| Example 2 | 20 | Provision | 99.5 | 99.3 | None | None |
| Comparative | 0 | Provision | 99.5 | 91.0 | Significant | Significant |
| Example 1 | | | | | occurrence | occurrence |
| Comparative | 20 | None | 99.2 | 96.2 | Occur- | None |
| Example 3 | | | | | rence | |
| Comparative | 0 | None | 99.0 | 92.5 | Significant | Significant |
| Example 4 | | | | | occurrence | occurrence |

As shown in Table 3, in all of Comparative Examples 3 and 4 in which an antioxidant was not included in a negative type liquid crystal composition, deterioration (oxidation) of liquid crystal or the photo-alignment film was caused, and screen image sticking occurring by the decrease of the VHR was viewed. In all of Comparative Examples 1 and 4 in which the photo-alignment film did not have the third side chain, significantly decrease of the VHR and surrounding stain were observed. From the above evaluation results, it was confirmed that the antioxidant in the liquid crystal composition and the —COOH-including third side chain in the photo-alignment film were required for suppressing the decrease of the VHR and suppressing the occurrence of screen image sticking and surrounding stain.

### SYNTHESIS EXAMPLES 11 TO 16

A polymer of the first component and a polymer of the second component were used together as the solid component of the liquid crystal aligning agent. The polymer of the first component is obtained by bonding the first side chain and the second side chain to reactive polysiloxane. Similarly to Synthesis Example 1, as the reactive polysiloxane, a compound in which X indicates a 2-(3,4-epoxycyclohexyl)ethyl group and Y indicates a methoxy group in Formula (1) was used. Similarly to Synthesis Example 1, as the first side chain, a group represented by Formula (33) including the photo-functional group was used. Similarly to Synthesis Example 1, as the second side chain, a group represented by Formula (34) including the photo-functional group was used. Similarly to Synthesis Example 1, the contents of the first side chain and the second side chain were respectively set to 15 mol % and 25 mol %, with respect to silicon atoms included in the main chain (reactive polysiloxane) of siloxane. As described above, the polymer of the first component is the same as the polymer used in Synthesis Example 1, except for not including the third side chain. In other words, the polymer of the first component is the same as the polymer used in Comparative Synthesis Example 1.

The polymer of the second component is an acrylic acid polymer which included —COOH in the side chain. The content of —COOH was 40 mol % with respect to the silicon atoms included in the main chain of siloxane.

The liquid crystal aligning agents in Synthesis Examples 11 to 16 were prepared by dissolving solid component which was formed from the polymer of the first component and the polymer of the second component, in a solvent. A blend ratio (weight ratio) of the first component and the second component in the solid component was 5:95 (Synthesis Example 11), 10:90 (Synthesis Example 12), 20:80 (Synthesis Example 13), 30:70 (Synthesis Example 14), 40:60 (Synthesis Example 15), or 50:50 (Synthesis Example 16), when the blend ratio was represented in a manner of first component:second component. As the solvent, a solvent mixture obtained by mixing N-methylpyrrolidone (NMP) and BC (ethylene glycol monobutyl ether, butyl cellosolve) at a weight ratio of 1:1 was used. The concentration of the solid component was set to 3.0 weight %.

Liquid crystal aligning agents in Synthesis Examples 11 to 16 were prepared in the above-described manner. The liquid crystal aligning agents were a material for a vertical alignment film, and could be applied to photo-alignment treatment.

### EXAMPLES 11 TO 16

Liquid crystal panels in Examples 11 to 16 were respectively manufactured by using the liquid crystal aligning agent in Synthesis Examples 11 to 16, in a manner similar to that in Example 1. A test of preservation-on-backlight was performed on the liquid crystal panels in Examples 11 to 16, under the following high-temperature and high-humidity condition in a manner similar to that in Example 1. Test results were collectively shown in the following Table 4.

TABLE 4

| | First | | | Liquid crystal panel | |
|---|---|---|---|---|---|
| | component/ | VHR (%) | | observation | |
| | second | | After | Screen image | Surrounding |
| | component | Initial | 500 hs | sticking | stain |
| Example | 5/95 | 98.2 | 96.5 | Occurrence | None |
| 11 | | | | | |
| Example | 10/90 | 99.3 | 98.5 | None | None |
| 12 | | | | | |
| Example | 20/80 | 99.5 | 98.8 | None | None |
| 13 | | | | | |
| Example | 30/70 | 99.5 | 97.5 | None | Slight |
| 14 | | | | | occurrence |
| Example | 40/60 | 99.5 | 97.0 | None | Slight |
| 15 | | | | | occurrence |
| Example | 50/50 | 99.5 | 95.0 | None | Occurrence |
| 16 | | | | | |

In Example 11 (first component: second component=5:95), the initial VHR was low and screen image sticking occurred. As the cause of the low initial VHR, there is a probability of an occurrence of a case where the amount of an acrylic acid polymer which is the second component is large, and thus the large amount of carboxylic acid having high polarity is provided in the alignment film, and a compound having high polarity, such as moisture or an ionic component is taken in at a stage of manufacturing the panel. Adhesiveness between the acrylic acid polymer and the sealing resin was good, and surrounding stain did not occur.

In Example 12 (first component:second component=10:90) and Example 13 (first component:second component=20:80), screen image sticking and surrounding stain did not occur. Thus, Examples 12 and 13 were good. It is considered that the reason is because moisture infiltration into a liquid crystal panel having good adhesiveness to the sealing resin is suppressed and —COOH in the acrylic acid polymer effectively captures a cinnamate group cleaved by backlight light, and thus the antioxidant in liquid crystal is not consumed. In Examples 11, 12, and 13, contrast of 5000 or more was ensured even after the panel had been left for 500 hours.

In Example 14 (first component:second component=30:70), Example 15 (first component:second component=40:60), and Example 16 (first component:second component=50:50), screen image sticking was not viewed, but surrounding stain was slightly confirmed. It is considered that the reason is because a component ratio of the acrylic acid polymer is reduced, and thus the amount of the acrylic acid polymer provided on the surface of the photo-alignment film is reduced, adhesiveness between the sealing resin and the photo-alignment film is degraded, and thus moisture infiltration is caused.

### SYNTHESIS EXAMPLES 17 TO 22

A liquid crystal aligning agent was prepared in a manner similar to that in Synthesis Examples 11 to 16, except for using polyamic acid (imidization ratio being less than 90%) as the polymer of the second component, and the blend ratio of the first component and the second component. A blend ratio (weight ratio) of the first component and the second component in Synthesis Example 17 to 22 was 5:95 (Synthesis Example 17), 10:90 (Synthesis Example 18), 15:85 (Synthesis Example 19), 20:80 (Synthesis Example 20), 25:75 (Synthesis Example 21), or 30:70 (Synthesis Example 22), when the blend ratio was represented in a manner of first component: second component. The imidization ratio of polyamic acid is a value measured by FT-IR.

### EXAMPLES 17 TO 22

Liquid crystal panels in Examples 17 to 22 were respectively manufactured by using the liquid crystal aligning agent in Synthesis Examples 17 to 22, in a manner similar to that in Example 1. A test of preservation-on-backlight was performed on the liquid crystal panels in Examples 17 to 22, under the following high-temperature and high-humidity condition in a manner similar to that in Example 1. Test results were collectively shown in the following Table 5.

TABLE 5

| | First | | | Liquid crystal panel | |
|---|---|---|---|---|---|
| | component/ | VHR (%) | | observation | |
| | second | | After | Screen image | Surrounding |
| | component | Initial | 500 hs | sticking | stain |
| Example | 5/95 | 98.5 | 97.5 | Occurrence | None |
| 17 | | | | | |
| Example | 10/90 | 99.5 | 98.8 | None | None |
| 18 | | | | | |
| Example | 15/85 | 99.5 | 98.8 | None | None |
| 19 | | | | | |
| Example | 20/80 | 99.5 | 98.2 | None | None |
| 20 | | | | | |
| Example | 25/75 | 99.5 | 97.3 | None | Slight |
| 21 | | | | | occurrence |
| Example | 30/70 | 99.5 | 96.5 | None | Occurrence |
| 22 | | | | | |

In Example 17 (first component:second component=5:95), the initial VHR was low and screen image sticking occurred. As the cause of the low initial VHR, there is a probability of an occurrence of a case where the amount of polyamic acid which is the second component is large, and thus the large amount of carboxylic acid having high polarity is provided in the photo-alignment film, and a compound having high polarity, such as moisture or an ionic component is taken in at a stage of manufacturing the panel. Adhesiveness between polyamic acid and the sealing resin was good, and surrounding stain did not occur.

In Example 18 (first component:second component=10:90), Example 19 (first component:second component=15:85), and Example 20 (first component:second component=20:80), screen image sticking and surrounding stain did not occur. Thus, Examples 18 to 20 were good. It is considered that the reason is because moisture infiltration into a liquid crystal panel having good adhesiveness between the polyamic acid and the sealing resin is suppressed and —COOH in the polyamic acid effectively captures a cinnamate group cleaved by backlight light, and thus the antioxidant in liquid crystal is not consumed. In Examples 18, 19, and 20, contrast of 5000 or more was ensured even after the panel had been left for 500 hours.

In Example 21 (first component:second component=25:75) and Example 22 (first component:second component=30:70), screen image sticking was not viewed, but surrounding stain was slightly confirmed. It is considered that the reason is because a component ratio of the polyamic acid is reduced, and thus the amount of the polyamic acid provided on the surface of the photo-alignment film is reduced, adhesiveness between the sealing resin and the photo-alignment film is degraded, and thus moisture infiltration is caused.

### SYNTHESIS EXAMPLES 23 TO 27 AND COMPARATIVE SYNTHESIS EXAMPLE 3

A polymer of the first component and a polymer of the second component were used together as the solid component of the liquid crystal aligning agent. Regarding the polymer of the first component, a polymer obtained by bonding the first side chain and the second side chain to reactive polysiloxane was prepared. As the reactive polysiloxane, a compound in which X indicates a 2-(3,4-epoxycyclohexyl)ethyl group and Y indicates a methoxy group in the following Formula (1) was used.

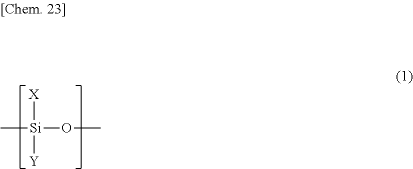

As the first side chain, a group represented by the following Formula (B-6) including phenol ester as the photo-functional group was used. As the second side chain, a group represented by the following Formula (H-1-1) including a carboxyl group (—COOH) was used.

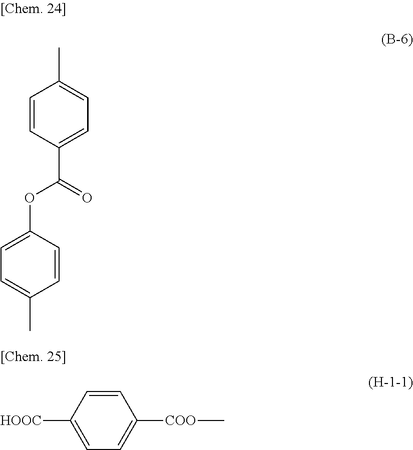

The content of the first side chain was set to 40 mol % with respect to the silicon atoms included in the main chain (reactive polysiloxane) of siloxane. The content of the second side chain was 0 mol % (Comparative Synthesis Example 3), 10 mol % (Synthesis Example 23), 20 mol % (Synthesis Example 24), 30 mol % (Synthesis Example 25), 40 mol % (Synthesis Example 26), or 50 mol % (Synthesis Example 27), with respect to silicon atoms included in the main chain (reactive polysiloxane) of siloxane. Synthesis Examples 23 to 27 are the same as each other except that the content of the second side chain is different from each other.

The polymer of the second component is polyamic acid having an imidization ratio being less than 90%, and includes —COOH in the side chain.

The liquid crystal aligning agents in Synthesis Examples 23 to 27 and Comparative Synthesis Example 3 were prepared by dissolving solid component which was formed from the polymer of the first component and the polymer of the second component, in a solvent. A blend ratio (weight ratio) of the first component and the second component in the solid component was 20:80 when being represented in a manner of first component:second component. As the solvent, a solvent mixture obtained by mixing N-methylpyrrolidone (NMP) and BC (ethylene glycol monobutyl ether, butyl cellosolve) at a weight ratio of 1:1 was used. The concentration of the solid component was set to 3.0 weight %.

Liquid crystal aligning agents in Synthesis Example 23 to 27 and Comparative Synthesis Example 3 were prepared in the above-described manner. The liquid crystal aligning agents were a material for a horizontal alignment film, and could be applied to photo-alignment treatment.

### EXAMPLES 23 TO 27 AND COMPARATIVE EXAMPLE 5

Liquid crystal panels in Examples 23 to 27 and Comparative Example 5 were respectively manufactured by using the liquid crystal aligning agents in Synthesis Examples 23 to 27 and Comparative Synthesis Example 3, in accordance with the following procedures (1) to (6).

(1) A glass substrate (TFT substrate) which had a TFT element and a transparent electrode having a double-layer structure was prepared, and a glass substrate (color filter substrate) which had only a black matrix, a color filter, an photospacer, and an overcoat layer for the color filter was prepared. The transparent electrode having a double-layer structure was formed by combining an ITO lower layer electrode and an ITO upper layer electrode which were disposed with an insulating interlayer in between. An electrode slit was provided in the upper layer electrode.

(2) The liquid crystal aligning agent was applied onto a surface of the washed TFT substrate on the transparent electrode side, and onto a surface of the washed color filter substrate on the overcoat layer side by an ink jet method. Then, drying was performed at 80° C. for 2 minutes. Then, firing was performed at 230° C. in a nitrogen atmosphere for 40 minutes, thereby a film having a film thickness of 100 nm was manufactured.

(3) The surface of each of the substrates was irradiated with an ultraviolet ray which was linearly polarized light having a wavelength of 313 nm, an extinction ratio of 10:1, and energy of 20 mJ/cm². The irradiation was performed as alignment treatment, from a normal direction of the substrate.

(4) An UV-curable and thermosetting sealing agent was applied on one substrate by using a dispenser. The UV-curable and thermosetting sealing agent was formed of an acrylic resin, an epoxy resin, an epoxy curing agent, a photopolymerization initiator, a silane coupling agent, and an inorganic and organic filler. As the silane coupling agent, 3-glycidoxypropyltrimethoxysilane (manufactured by Shin-Etsu Chemical Co., Ltd., brand name: SHIN-ETSU SILICONES (registered trademark), product name: KBM403) was used. A negative type liquid crystal composition was dropped to a predetermined position on the other substrate. The negative type liquid crystal composition included 50 to 500 ppm of a dibutylhydroxyphenyl compound as an antioxidant. A pair of substrates were adhered to each other under vacuum. Further, the sealing agent on the adhered substrate was cured by ultraviolet light, thereby a liquid crystal panel was obtained.

(5) The obtained liquid crystal panel was heated at 130° C. so as to perform re-alignment treatment of liquid crystal.

(6) A pair of polarizers disposed to be in crossed Nicols state were disposed to sandwich the liquid crystal panel. The polarizers were disposed to cause a polarization axis thereof to coincide with an irradiation direction in which the photo-alignment film was irradiated with an ultraviolet ray. As a result, a liquid crystal panel of the fringe field switching mode (FFS mode) was completed.

FIG. 16 is a schematic diagram illustrating a configuration of a liquid crystal panel in a FFS mode, which is manufactured in Examples 23 to 27 and Comparative Example 5. As illustrated in FIG. 16, in the FFS mode liquid crystal panel manufactured in Examples 23 to 27 and Comparative Example 5, a TFT substrate 210 on which a lower layer electrode 211, an insulating interlayer 212, and a pixel electrode 213 are stacked opposes a color filter substrate 220 on which a color filter 221 and an overcoat 222 are stacked, through a liquid crystal layer 230 which contains liquid crystal molecules 231. Photo-alignment films 240 are respectively formed on surfaces of the TFT substrate 210 and the color filter substrate 220, which are in contact with the liquid crystal layer 230. Polarizers 260 are respectively provided on the other surfaces of the TFT substrate 210 and the color filter substrate 220.

A liquid crystal driving circuit and a backlight were attached to the FFS mode liquid crystal panel in each of Examples 23 to 27 and Comparative Example 5, and a test of preservation-on-backlight was performed under the following high-temperature and high-humidity condition in a manner similar to that in Example 1. Test results were collectively shown in the following Table 6.

TABLE 6

| | Second | VHR (%) | | Liquid crystal panel observation | |
|---|---|---|---|---|---|
| | side chain | | After | Screen image | Surrounding |
| | (mol %) | Initial | 500 hs | sticking | stain |
| Comparative | 0 | 99.5 | 93.5 | Occurrence | Occurrence |
| Example 5 | | | | | |
| Example 23 | 10 | 99.5 | 98.2 | Slight | Slight |
| | | | | occurrence | occurrence |
| Example 24 | 20 | 99.5 | 99.5 | None | None |
| Example 25 | 30 | 99.5 | 99.0 | None | None |
| Example 26 | 40 | 99.0 | 97.6 | Occurrence | None |
| Example 27 | 50 | 98.5 | 96.5 | Occurrence | None |

In Comparative Example 5 (content of third side chain: 0 mol %), the VHR was greatly decreased after the panel had been left for 500 hours, and screen image sticking and surrounding stain were observed. It is considered that the reason is because moisture infiltration from the interface between the sealing material and the photo-alignment film occurs or the photo-alignment film and liquid crystal are deteriorated. It is considered that deterioration of the photo-alignment film and the liquid crystal occurs due to that a phenol ester group of the photo-alignment film has been cleaved by backlight light, radicals have been generated, and thus the antioxidant in liquid crystal has been consumed.

In Example 23 (content of second side chain: 10 mol %), after the panel had been left for 500 hours, the VHR was decreased to be small, and the occurrence of screen image sticking and surrounding stain was observed at some portion of the panel. However, all of the degree of the decrease of the VHR and the degree of the occurrence of screen image sticking and surrounding stain were improved in comparison to those in Comparative Example 5.

In Examples 24 and 25 (content of second side chain: 20 and 30 mol %), after the panel had been left for 500 hours, the VHR was hardly decreased, and the degree of the occurrence of screen image sticking and surrounding stain was also significantly improved. The reason is because of contribution of both effects. One is that —COOH was introduced at the terminal in the photo-alignment film, and thus it was possible to improve adhesiveness to the sealing material, and to hinder moisture infiltration from the outside of the liquid crystal panel. The other is that —COOH effectively captured a phenol ester group cleaved by backlight light, and thus the antioxidant in the liquid crystal was not consumed.

In Examples 26 and 27 (content of third side chain: 40 and 50 mol %), surrounding stain was not observed, but screen image sticking was observed. As the cause, it is considered that the content of —COOH is increased, and thus an initial VHR before the panel is left for 500 hours is reduced. As the cause of reducing the initial VHR, there is a probability of an occurrence of a case where, since carboxylic acid has high polarity, a compound having high polarity, such as moisture or an ionic component is taken in at a stage of manufacturing the panel.

### [Appendix]

According to one aspect of the present invention, a liquid crystal display device may include a pair of substrates, a liquid crystal layer which is interposed between the pair of substrates, a sealing material which is disposed around the liquid crystal layer and bonds the pair of substrates to each other, and a photo-alignment film which is disposed between at least one of the pair of substrates, and the liquid crystal layer and the sealing material. The liquid crystal layer may contain liquid crystal molecules and an antioxidant. The sealing material may be obtained by curing a sealing resin which contains a compound having at least one first bonding functional group which is selected from the group consisting of an epoxy group, a methoxy silane group, and an ethoxy silane group. The photo-alignment film may contain at least one alignment film polymer which includes an ester group in a main chain or a side chain. The at least one alignment film polymer may include a photo-alignment film polymer which includes at least one photo-functional group selected from the group consisting of a cinnamate group, a chalconyl group, an azobenzene group, a coumarin group, a stilbene group, and a phenol ester group. At least one second bonding functional group which is selected from the group consisting of —COOH, —NH₂, —NHR (R indicates an aliphatic or alicyclic hydrocarbon having 1 to 18 carbon atoms, or indicates a structure in which a hydroxyl group and/or a halogen group is added to the hydrocarbon), —SH, and —OH may be provided on a surface of the photo-alignment film. According to the aspect, it is possible to improve adhesive strength of the photo-alignment film to the sealing material or to deactivate radicals generated from the photo-functional group or the ester group, by the second bonding functional group provided in the surface of the photo-alignment film. Thus, it is possible to maintain a good voltage holding ratio for a long term and prevent the occurrence of image sticking and stain on a display screen, by using the photo-alignment film.

In a first configuration included in the aspect, the photo-alignment film polymer includes a main chain having a polysiloxane structure and a side chain combined to the main chain. The side chain includes the ester group, the photo-functional group, and the second bonding functional group, and includes at least one of the epoxy group and the structure derived from the epoxy group. According to such a photo-alignment film polymer, it is possible to obtain excellent heat resistance, and to sufficiently obtain the effect by the second bonding functional group.

In the first configuration, it is preferable that the photo-alignment film polymer is represented by the following Formula (1).

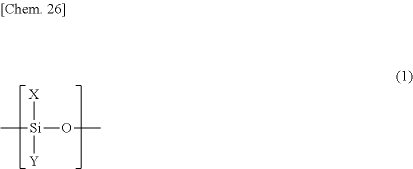

(in Formula (1), X indicates the side chain which includes at least one of the epoxy group and the structure derived from the epoxy group, Y indicates a hydroxyl group, an alkoxyl group having 1 to 10 carbon atoms, an alkyl group having 1 to 6 carbon atoms, or an aryl group having 6 to 10 carbon atoms.)

In the first configuration, it is preferable that the content of the side chain including the second bonding functional group is preferably more than 0 mol % and 40 mol % or less with respect to silicon atoms included in the main chain. The content is set to be in the above range, and thus it is possible to sufficiently exhibit an advantageous effect of improving adhesive strength at the interface between the sealing material and the photo-alignment film, and an advantageous effect of reducing the consumed amount of the antioxidant. As a result, it is possible to sufficiently suppress the longitudinal decrease of the VHR.

In the first configuration, the second bonding functional group is represented by the following Formula (H-a) or the following Formula (H-b).

[Chem. 27]

Z-A¹P-A²ₙCOOH (H-a)

(in Formula (H-a), Z indicates the second bonding functional group. A¹ and A² are the same as each other or different from each other, and indicate 1,4-phenylene, 1,3-phenylene, 1,2-phenylene, 1,4-cyclohexylene, 1,3-cyclohexylene, or 1,2-cyclohexylene. P indicates —COO—, —OCO—, —O—, —CONH—, —NHCO—, or direct bonding. n indicates 0, 1, or 2.)

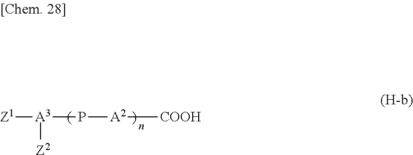

(in Formula (H-b), Z¹ and Z² indicate the second bonding functional group of the same or different type. A³ indicates 1,2,3-phenylene, 1,2,4-phenylene, 1,3,4-phenylene, 1,2,3-cyclohexylene, 1,2,4-cyclohexylene, or 1,3,4-cyclohexylene. P indicates —COO—, —OCO—, —O—, —CONH—, —NHCO—, or direct bonding. A² indicates 1,4-phenylene, 1,3-phenylene, 1,2-phenylene, 1,4-cyclohexylene, 1,3-cyclohexylene, or 1,2-cyclohexylene. n indicates 0, 1, or 2.)

A substance obtained by bonding —COOH in Formula (H-a) or (H-b) to the epoxy group included in X in Formula (1) is suitably used.

In a second configuration included in the aspect, the photo-alignment film contains a first component formed of the photo-alignment film polymer, and a second component formed of the other alignment film polymer which includes the second bonding functional group. The other alignment film polymer has a main chain having a structure of polysiloxane, polyacryl, polymethacryl, or polyvinyl. With such a photo-alignment film, it is also possible to sufficiently obtain the effect by the second bonding functional group.

In the second configuration, it is preferable that the photo-alignment film polymer is represented by the following Formula (1).

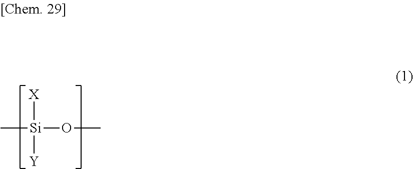

(in Formula (1), X indicates a side chain which includes at least one of an epoxy group or a structure derived from the epoxy group, and Y indicates a hydroxyl group, an alkoxyl group having 1 to 10 carbon atoms, an alkyl group having 1 to 6 carbon atoms, or an aryl group having 6 to 10 carbon atoms.)

The mixing ratio of the first component is preferably more than 5 weight % and less than 30 weight % with respect to the total amount of the first component and the second component. The mixing ratio is set to be in the above range, and thus it is possible to sufficiently exhibit an advantageous effect of improving adhesive strength at the interface between the sealing material and the photo-alignment film, and an advantageous effect of reducing the consumed amount of the antioxidant. As a result, it is possible to sufficiently suppress the longitudinal decrease of the VHR.

In a third configuration included in the aspect, it is preferable that the photo-alignment film contains a first component formed of the photo-alignment film polymer, and a second component formed of the other alignment film polymer which includes the second bonding functional group, and the other alignment film polymer is polyamic acid having an imidization ratio being less than 90%. With such a photo-alignment film, it is also possible to sufficiently obtain the effect by the second bonding functional group.

In the third configuration, it is preferable that the photo-alignment film polymer is represented by the following Formula (1).

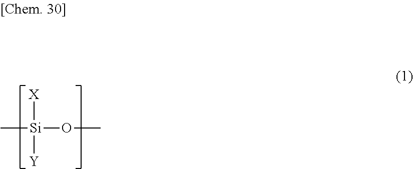

(in Formula (1), X indicates a side chain which includes at least one of an epoxy group or a structure derived from the epoxy group, and Y indicates a hydroxyl group, an alkoxyl group having 1 to 10 carbon atoms, an alkyl group having 1 to 6 carbon atoms, or an aryl group having 6 to 10 carbon atoms.)

In the third configuration, it is preferable that the mixing ratio of the first component is preferably more than 5 weight % and less than 25 weight % with respect to the total amount of the first component and the second component. The mixing ratio is set to be in the above range, and thus it is possible to sufficiently exhibit an advantageous effect of improving adhesive strength at the interface between the sealing material and the photo-alignment film, and an advantageous effect of reducing the consumed amount of the antioxidant. As a result, it is possible to sufficiently suppress the longitudinal decrease of the VHR.

The photo-alignment film polymer may include at least one of the cinnamate group and the phenol ester group, as the photo-functional group. The cinnamate group and the phenol ester group are the photo-functional group which includes an ester group. The second bonding functional group is particularly effectively applied.

The photo-alignment film may give a pretilt angle of 86° or more and less than 90° to the liquid crystal molecules. As described above, the pretilt angle is given, and thus a liquid crystal display device of a vertical alignment mode is obtained.

The antioxidant may include a dibutylhydroxyphenyl compound. Thus, it is possible to sufficiently prevent an occurrence of a situation in which an alkyl group (R) and the like included in the liquid crystal layer, the photo-alignment film, and the sealing material are oxidized by oxygen infiltrated into the liquid crystal panel, and radicals generated from the oxidized substance causes the decrease of the VHR.

The compound having the first bonding functional group may be a silane coupling agent or an epoxy monomer. As the silane coupling agent, a substance represented by the following Formula (2) is suitably used. Thus, it is possible to sufficiently improve adhesive strength between the sealing material and the photo-alignment film.

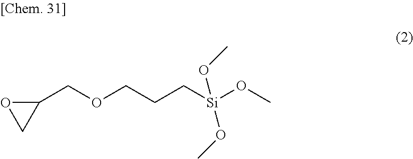

The second bonding functional group may include at least one of —COOH and —OH. In this case, it is preferable that —COOH or —OH is chemically bonded to the silane coupling agent at the interface between the photo-alignment film and the sealing material, and thus a structure represented by the following Formula (3) is formed.

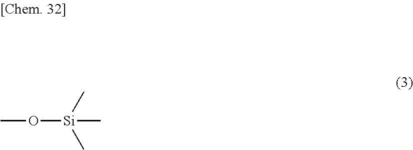

The second bonding functional group may include at least one of —NH₂, —NHR, and —SH. In this case, it is preferable that —NH₂, —NHR, or —SH is chemically bonded to the epoxy group at the interface between the photo-alignment film and the sealing material, and thus a structure represented by the following Formula (4-1), (4-2), or (4-3) is formed.

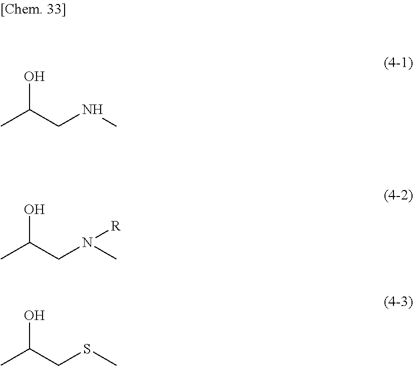

The aspects of the present invention described above may be appropriately combined in a range without departing from the gist of the present invention.

### REFERENCE SIGNS LIST

10, 20: SUBSTRATE

30: LIQUID CRYSTAL LAYER

40: PHOTO-ALIGNMENT FILM

50: SEALING MATERIAL

60: POLARIZER

80: BACKLIGHT

110: PHOTO-ALIGNMENT FILM

111: LIQUID CRYSTAL MOLECULE

112: UPPER AND LOWER SUBSTRATES

113: PHOTOMASK

114: LIGHT SHIELDING PORTION

115: DIRECTION OF ABSORPTION AXIS OF POLARIZER DISPOSED ON UPPER SUBSTRATE SIDE

116: DIRECTION OF ABSORPTION AXIS OF POLARIZER DISPOSED ON LOWER SUBSTRATE SIDE

117: LIQUID CRYSTAL DIRECTOR DIRECTION

210: TFT SUBSTRATE

211: LOWER LAYER ELECTRODE

212: INSULATING INTERLAYER

213: PIXEL ELECTRODE

220: COLOR FILTER SUBSTRATE

221: COLOR FILTER

222: OVERCOAT

230: LIQUID CRYSTAL LAYER

231: LIQUID CRYSTAL MOLECULE

240: PHOTO-ALIGNMENT FILM

260: POLARIZER

1. A liquid crystal display device comprising:
a pair of substrates;
a liquid crystal layer which is interposed between the pair of substrates;
a sealing material which is disposed around the liquid crystal layer and bonds the pair of substrates to each other; and
a photo-alignment film which is disposed between at least one of the pair of substrates, and the liquid crystal layer and the sealing material, wherein
the liquid crystal layer contains liquid crystal molecules and an antioxidant,
the sealing material is obtained by curing a sealing resin which contains a compound having at least one first bonding functional group which is selected from the group consisting of an epoxy group, a methoxy silane group, and an ethoxy silane group,
the photo-alignment film contains at least one alignment film polymer which includes an ester group in a main chain or a side chain,
the at least one alignment film polymer includes a photo-alignment film polymer which includes at least one photo-functional group selected from the group consisting of a cinnamate group, a chalconyl group, an azobenzene group, a coumarin group, a stilbene group, and a phenol ester group, and
at least one second bonding functional group which is selected from the group consisting of —COOH, —NH₂, —NHR (R indicates an aliphatic or alicyclic hydrocarbon having 1 to 18 carbon atoms, or indicates a structure in which a hydroxyl group and/or a halogen group is added to the hydrocarbon), —SH, and —OH is provided on a surface of the photo-alignment film.

2. The liquid crystal display device according to claim 1, wherein
the photo-alignment film polymer includes the main chain having a polysiloxane structure and the side chain combined to the main chain, and
the side chain includes the ester group, the photo-functional group, and the second bonding functional group, and includes at least one of an epoxy group and a structure derived from the epoxy group.

3. The liquid crystal display device according to claim 2, wherein
the photo-alignment film polymer is represented by the following Formula (1). 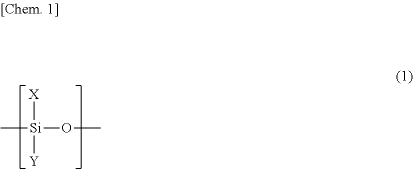
(in Formula (1), X indicates the side chain which includes at least one of the epoxy group and the structure derived from the epoxy group, Y indicates a hydroxyl group, an alkoxyl group having 1 to 10 carbon atoms, an alkyl group having 1 to 6 carbon atoms, or an aryl group having 6 to 10 carbon atoms.)

4. The liquid crystal display device according to claim 2, wherein
the content of the side chain including the second bonding functional group is more than 0 mol % and equal to or less than 40 mol % with respect to silicon atoms included in the main chain.

5. The liquid crystal display device according to claim 3, wherein
the second bonding functional group is represented by the following Formula (H-a) or the following Formula (H-b), and
[Chem. 2]
Z-A¹P-A²ₙCOOH (H-a)
(in Formula (H-a), Z indicates the second bonding functional group. A¹ and A² are the same as each other or different from each other, and indicate 1,4-phenylene, 1,3-phenylene, 1,2-phenylene, 1,4-cyclohexylene, 1,3-cyclohexylene, or 1,2-cyclohexylene. P indicates —COO—, —OCO—, —O—, —CONH—, —NHCO—, or direct bonding. n indicates 0, 1, or 2.) 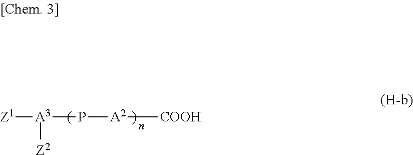
(in Formula (H-b), Z¹ and Z² indicate the second bonding functional group of the same or different type. A³ indicates 1,2,3-phenylene, 1,2,4-phenylene, 1,3,4-phenylene, 1,2,3-cyclohexylene, 1,2,4-cyclohexylene, or 1,3,4-cyclohexylene. P indicates —COO—, —OCO—, —O—, —CONH—, —NHCO—, or direct bonding. A² indicates 1,4-phenylene, 1,3-phenylene, 1,2-phenylene, 1,4-cyclohexylene, 1,3-cyclohexylene, or 1,2-cyclohexylene. n indicates 0, 1, or 2.)
—COOH in Formula (H-a) and Formula (H-b) is bonded to an epoxy group included in X in Formula (1).

6. The liquid crystal display device according to claim 1, wherein
the photo-alignment film contains a first component formed of the photo-alignment film polymer, and a second component formed of another alignment film polymer which includes the second bonding functional group, and
the other alignment film polymer includes a main chain having a structure of polysiloxane, polyacryl, polymethacryl, or polyvinyl.

7. The liquid crystal display device according to claim 6, wherein
the photo-alignment film polymer is represented by the following Formula (1). 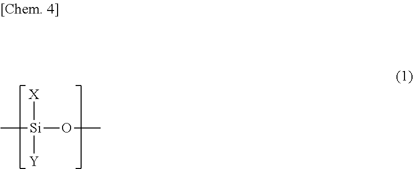
(in Formula (1), X indicates a side chain which includes at least one of an epoxy group or a structure derived from the epoxy group, and Y indicates a hydroxyl group, an alkoxyl group having 1 to 10 carbon atoms, an alkyl group having 1 to 6 carbon atoms, or an aryl group having 6 to 10 carbon atoms.)

8. The liquid crystal display device according to claim 6, wherein
a mixing ratio of the first component is more than 5 weight % and less than 30 weight % with respect to the total amount of the first component and the second component.

9. The liquid crystal display device according to claim 1, wherein
the photo-alignment film contains a first component formed of the photo-alignment film polymer, and a second component formed of another alignment film polymer which includes the second bonding functional group, and
the other alignment film polymer is polyamic acid having an imidization ratio which is less than 90%.

10. The liquid crystal display device according to claim 9, wherein
the photo-alignment film polymer is represented by the following Formula (1). 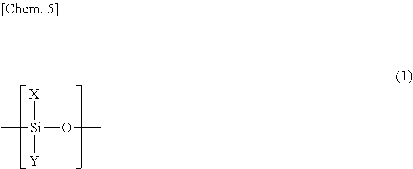
(in Formula (1), X indicates a side chain which includes at least one of an epoxy group or a structure derived from the epoxy group, and Y indicates a hydroxyl group, an alkoxyl group having 1 to 10 carbon atoms, an alkyl group having 1 to 6 carbon atoms, or an aryl group having 6 to 10 carbon atoms.)

11. The liquid crystal display device according to claim 9, wherein
a mixing ratio of the first component is more than 5 weight % and less than 25 weight % with respect to the total amount of the first component and the second component.

12. The liquid crystal display device according to claim 1, wherein
the photo-alignment film polymer includes at least one of the cinnamate group and the phenol ester group, as the photo-functional group.

13. The liquid crystal display device according to claim 1, wherein
the photo-alignment film gives a pretilt angle of 86° or more and less than 90° to the liquid crystal molecules.

14. The liquid crystal display device according to claim 1, wherein
the antioxidant includes a dibutylhydroxyphenyl compound.

15. The liquid crystal display device according to claim 1, wherein
the compound having the first bonding functional group is a silane coupling agent.

16. The liquid crystal display device according to claim 1, wherein
the silane coupling agent is represented by the following Formula (2).

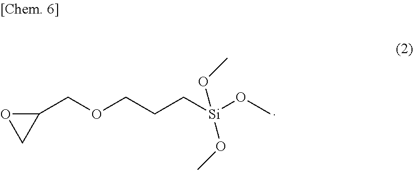

17. The liquid crystal display device according to claim 1, wherein
the second bonding functional group includes at least one of —COOH and —OH.

18. The liquid crystal display device according to claim 1, wherein
the second bonding functional group includes at least one of —NH₂, —NHR, and —SH.

19. The liquid crystal display device according to claim 1, wherein
the liquid crystal molecule has negative dielectric anisotropy.
